(19) United States
(12) Patent Application Publication
(10) Pub. No.: US 2021/0158274 A1
(43) Pub. Date: May 27, 2021

(54) COLLECTABLE CARD CLASSIFICATION SYSTEM

(71) Applicant: Card Kingdom, Inc., Seattle, WA (US)

(72) Inventor: Sean Patchen, Seattle, WA (US)

(21) Appl. No.: 16/696,502

(22) Filed: Nov. 26, 2019

(51) Int. Cl. G06Q 10/08; G06N 3/04; G06K 9/00; G06K 9/62

(52) U.S. Cl. CPC G06Q 10/087; G06N 3/04; G06K 2209/01; G06K 9/6267; G06K 9/00442

(57) ABSTRACT

A system for automatically classifying collectable cards. The system can include an image capture device and a controller. The controller can include one or more processors and one or more memory devices having stored thereon instructions that when executed by the one or more processors cause the one or more processors to receive image data from the image capture device corresponding to a collectable card, determine a card style for the collectable card based on the image data, process the image data according to the card style, and assign a unique stock keeping unit (SKU) number to the collectable card.

### BACKGROUND

There are many types of collectable cards including magic cards, game cards, and sports cards, to name a few. In many cases these cards are collected and traded among card enthusiasts. In some cases card collections can become quite large including hundreds if not thousands of cards. In a retail setting, identifying, classifying, and valuing these large collections can be laborious and prone to human error. Accordingly, there is a need to efficiently and accurately identify collectable cards.

### SUMMARY

Disclosed herein are methods and systems for automatically classifying collectable cards. The disclosed technology is a deep learning neural network designed to identify collectible cards in an efficient and accurate manner. In some embodiments, the network classifies cards by printing style, printing age, card ID, and print variation, for example. The network can use a combination of different types of machine learning blocks being connected and controlled by scripting blocks to control the data flow to the most relevant and efficient processing path. The result is a system that can identify all cards that have been printed in the past as well as identifying unknown cards that will be printed in the future.

In some embodiments, a system for automatically classifying collectable cards can include an image capture device and a controller configured for classifying the cards. The controller can include one or more processors and one or more memory devices having stored thereon instructions. When the instructions are executed by the processor(s) the processor(s) can receive image data from the image capture device corresponding to a collectable card and determine a card style for the collectable card based on the image data. The image data can be processed according to the card style and a unique stock keeping unit (SKU) number is assigned to the collectable card.

In some implementations, the card style can be determined based at least in part on a color of an outer border of the collectable card. The card style can be determined at least in part by whether the collectable card has a fixed or variable width title. In some cases, the unique SKU number can be read from an optical character recognition (OCR) readable tag on the collectable card. In some embodiments, processing the image data includes converting the image data to gray scale. Processing the image data can include excluding a selected color from the image data before converting the image to gray scale.

In some embodiments, a method for automatically classifying collectable cards can include receiving, with a controller, image data corresponding to a collectable card and determining, by the controller, a card style for the collectable card based on the image data. The method can further include processing, with the controller, the image data according to the card style and assigning, with the controller, a unique SKU number to the collectable card.

In some embodiments, a processor readable memory device can include instructions stored thereon that when executed by one or more processors, cause the one or more processors to: receive image data corresponding to a collectable card; determine a card style for the collectable card based on the image data; process the image data according to the card style; and assign a unique SKU number to the collectable card.

### BRIEF DESCRIPTION OF THE DRAWINGS

The systems and methods described herein may be better understood by referring to the following Detailed Description in conjunction with the accompanying drawings, in which like reference numerals indicate identical or functionally similar elements:

FIG. 1 illustrates an example simplified block diagram of a system for automatically classifying collectable cards according to representative embodiments of the disclosed technology;

FIG. 2 is a block diagram illustrating an overview of a representative card classification method;

FIGS. 3A-3D are block diagrams illustrating a card classification method according to representative embodiments of the disclosed technology;

FIG. 4 is a block diagram illustrating an overview of devices on which some implementations can operate;

FIG. 5 is a block diagram illustrating an overview of an environment in which some implementations can operate;

FIG. 6 is a block diagram illustrating components which, in some implementations, can be used in a system employing the disclosed technology;

FIG. 7 is a block diagram illustrating an overall structure of a card classification neural network according to representative embodiments of the disclosed technology;

FIGS. 8 and 9 are block diagrams illustrating a neural network structure for an age and border type classification subtask according to representative embodiments of the disclosed technology;

FIGS. 10 and 11 are a block diagram illustrating a neural network structure for meta-tag classification and an example collectable card image according to representative embodiments of the disclosed technology;

FIGS. 12 and 13 are a block diagram illustrating a neural network structure for vintage card classification and an example collectable card image according to representative embodiments of the disclosed technology;

FIGS. 14 and 15 are a block diagram illustrating a neural network structure for frontier classification and an example collectable card image according to representative embodiments of the disclosed technology;

FIGS. 16 and 17 are a block diagram illustrating a neural network structure for modern classification and an example collectable card image according to representative embodiments of the disclosed technology;

FIGS. 18 and 19 are a block diagram illustrating a neural network structure for legacy classification and an example collectable card image according to representative embodiments of the disclosed technology;

FIGS. 20 and 21 are a block diagram illustrating a neural network structure for future classification and an example collectable card image according to representative embodiments of the disclosed technology;

FIGS. 22 and 23 are a block diagram illustrating a neural network structure for invocation classification and an example collectable card image according to representative embodiments of the disclosed technology;

FIGS. 24 and 25 are a block diagram illustrating a neural network structure for specialized classification and an example collectable card image according to representative embodiments of the disclosed technology;

FIGS. 26-28 are a block diagrams illustrating an overall structure of a frontier card classification neural network according to representative embodiments of the disclosed technology;

FIGS. 29 and 30 are a block diagram illustrating a neural network structure for frontier features size and orientation and example collectable card images according to representative embodiments of the disclosed technology;

FIGS. 31 and 32 are a block diagram illustrating a neural network structure for frontier rarity OCR features and example collectable card images according to representative embodiments of the disclosed technology;

FIGS. 33-35 are a block diagram illustrating a neural network structure for frontier primary OCR features and example collectable card images according to representative embodiments of the disclosed technology;

FIGS. 36 and 37 are a block diagram illustrating a neural network structure for frontier foil features and example collectable card images according to representative embodiments of the disclosed technology;

FIG. 38 is a block diagram illustrating a neural network structure for a frontier unstable variant subtask according to representative embodiments of the disclosed technology;

FIGS. 39 and 40 are a block diagram illustrating a neural network structure for frontier art variation and an example collectable card image according to representative embodiments of the disclosed technology;

FIGS. 41 and 42 are a block diagram illustrating a neural network structure for frontier text box variation and an example collectable card image according to representative embodiments of the disclosed technology;

FIG. 43 is a block diagram illustrating a neural network structure for a frontier prerelease subtask according to representative embodiments of the disclosed technology;

FIGS. 44 and 45 are a block diagram illustrating a neural network structure for frontier set symbol features and example collectable card images according to representative embodiments of the disclosed technology; and

FIGS. 46 and 47 are a block diagram illustrating a neural network structure for frontier date stamp classification and an example collectable card image according to representative embodiments of the disclosed technology.

The headings provided herein are for convenience only and do not necessarily affect the scope of the embodiments. Further, the drawings have not necessarily been drawn to scale. For example, the dimensions of some of the elements in the figures may be expanded or reduced to help improve the understanding of the embodiments. Moreover, while the disclosed technology is amenable to various modifications and alternative forms, specific embodiments have been shown by way of example in the drawings and are described in detail below. The intention, however, is not to unnecessarily limit the embodiments described. On the contrary, the embodiments are intended to cover all modifications, combinations, equivalents, and alternatives falling within the scope of this disclosure.

### DETAILED DESCRIPTION

Various examples of the systems and methods introduced above will now be described in further detail. The following description provides specific details for a thorough understanding and enabling description of these examples. One skilled in the relevant art will understand, however, that the techniques and technology discussed herein may be practiced without many of these details. Likewise, one skilled in the relevant art will also understand that the technology can include many other features not described in detail herein. Additionally, some well-known structures or functions may not be shown or described in detail below so as to avoid unnecessarily obscuring the relevant description.

The terminology used below is to be interpreted in its broadest reasonable manner, even though it is being used in conjunction with a detailed description of some specific examples of the embodiments. Indeed, some terms may even be emphasized below; however, any terminology intended to be interpreted in any restricted manner will be overtly and specifically defined as such in this section.

The disclosed collectable card classifying technology is generally directed to retail environments where large card collections are purchased and sold. However, the disclosed technology can be used in any suitable setting where cards need to be classified and/or verified. Although various embodiments of the present card classifying technology are shown and described with respect to magic card games (e.g. Magic: The Gathering (MTG)), the technology is applicable to other card types, such as for example and without limitation, collectable card games (e.g., Pokeman), playing cards, and sports cards (e.g., baseball cards).

The disclosed methods and systems for automatically classifying collectable cards can accurately and efficiently classify large stacks of incoming cards. The system uses automated card handling and image capture coupled with a deep learning neural network to identify collectible cards based on printing style, printing age, card ID, and print variation, for example. The system can quickly classify cards by first identifying the type and style of card and then further processing the card based on the style of card. Thus, the various steps necessary to assign a SKU to a card is narrowed allowing the system to quickly identify the card with minimal processing power thereby reducing the need for server-level processing capabilities.

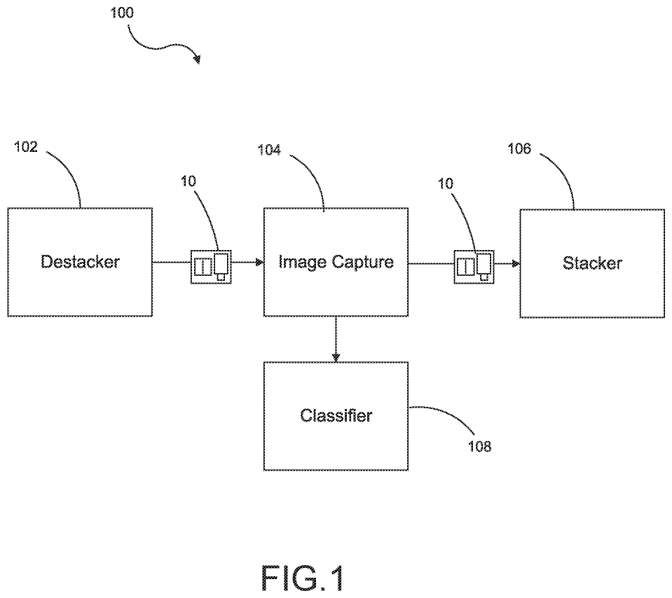

FIG. 1 illustrates an example simplified block diagram of a system 100 for automatically classifying collectable cards configured in accordance with representative embodiments of the disclosed technology. The system 100 can include automated card handling equipment, such as a destacker 102 and a stacker 106. The destacker 102 slides cards 10 off of a stack one at a time and feeds them through an image capture station 104 (e.g., camera and lights) where an image of each card 10 is captured digitally. In some embodiments, the system can capture images of both sides of each card. The stacker 106 restacks the cards in the reverse order. The destacker 102, stacker 106, and image capture equipment 104 are known in the art and are readily available from various automation integrators and suppliers. Once the images of the cards are captured a classification computer 108 analyzes the image data to classify each card.

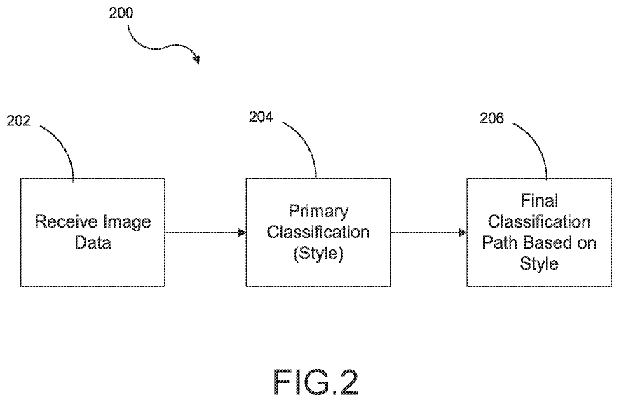

FIG. 2 is a block diagram illustrating an overview of a representative card classification method 200. The method 200 can include receiving image data at step 202 from an image capture device, such as image capture station 104 (FIG. 1). At step 204 a primary classification of the card (e.g., style) is determined based on various card characteristics, such as border color, presence of OCR readable tags, presence of collector numbers, special frames, and whether the card has a variable width title or a fixed width title, for example. In the case of Magic: the Gathering cards, these cards can be preliminarily classified as one of various styles including Vintage, Frontier, Modern, Legacy, Future, Invocation, and Specialized Tokens, for example. Once the primary classification is completed at step 204, i.e., once the card style is determined, the image data is further analyzed at step 206 based on the style determination to assign a final classification and/or a unique SKU number to the card.

In some embodiments, the system can process the image data by converting the image data to gray scale prior to image analysis (e.g., OCR). Processing the image data can include excluding a selected color from the image data before converting the image to gray scale in order to improve feature recognition. For example some cards have a foil marking which presents as a rainbow effect. By removing this color prior to gray scale conversion, feature recognition can be improved. In some embodiments, the Levenshtein distance formula is applied to feature recognition in the form of an array that determines the lowest number of pixel matches needed to be reasonably sure that a feature is present.

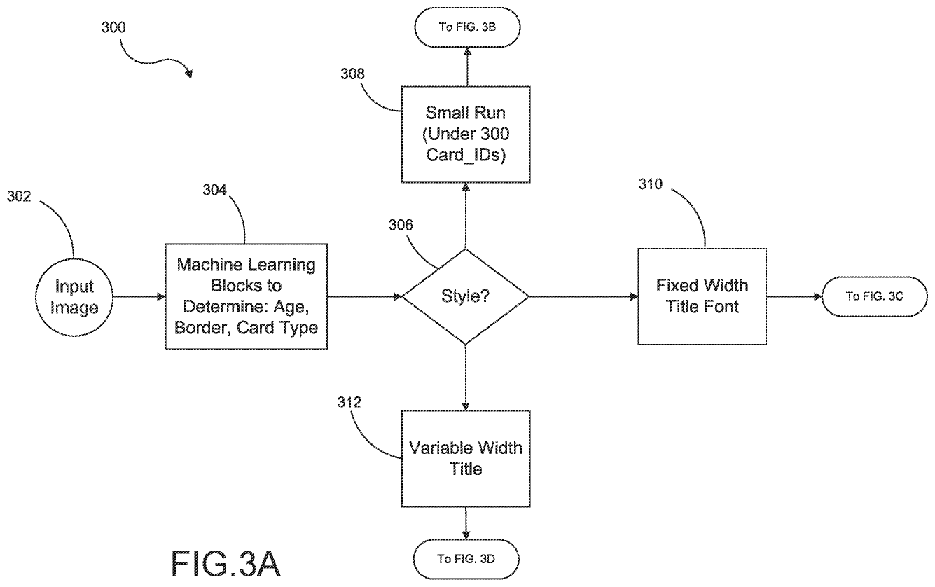

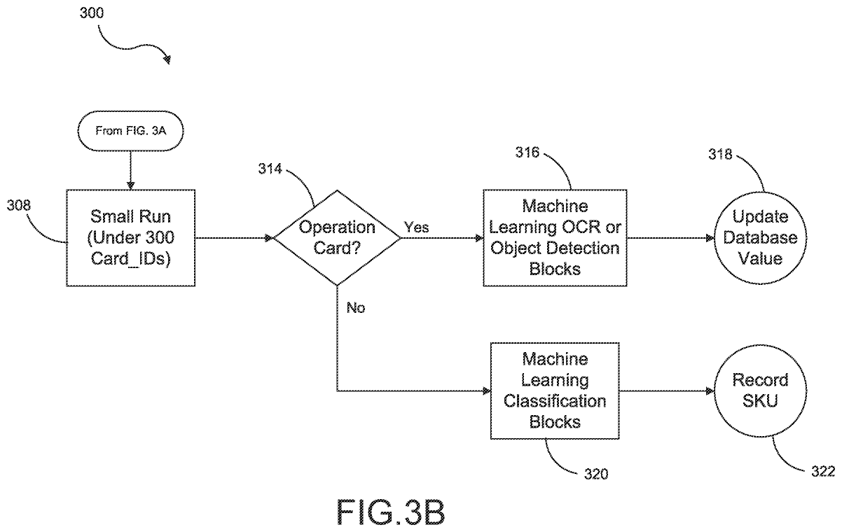

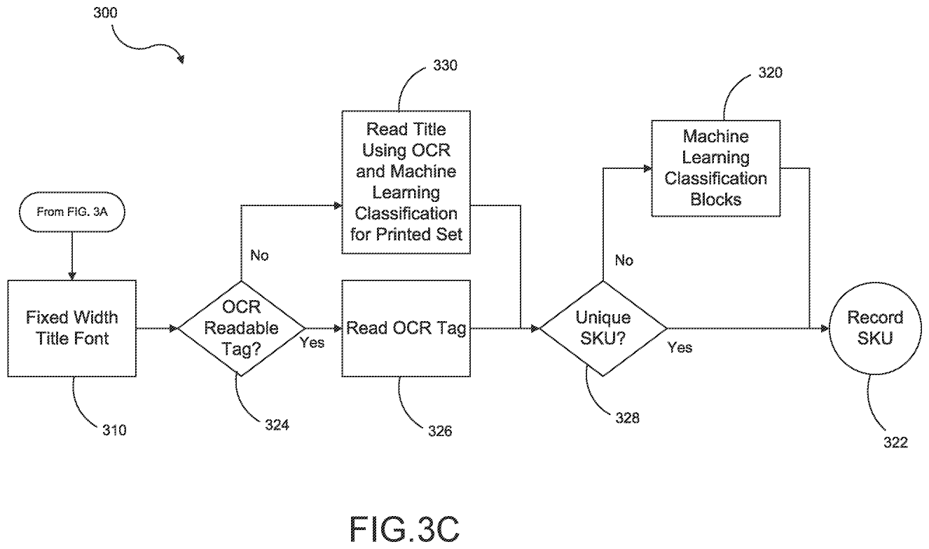

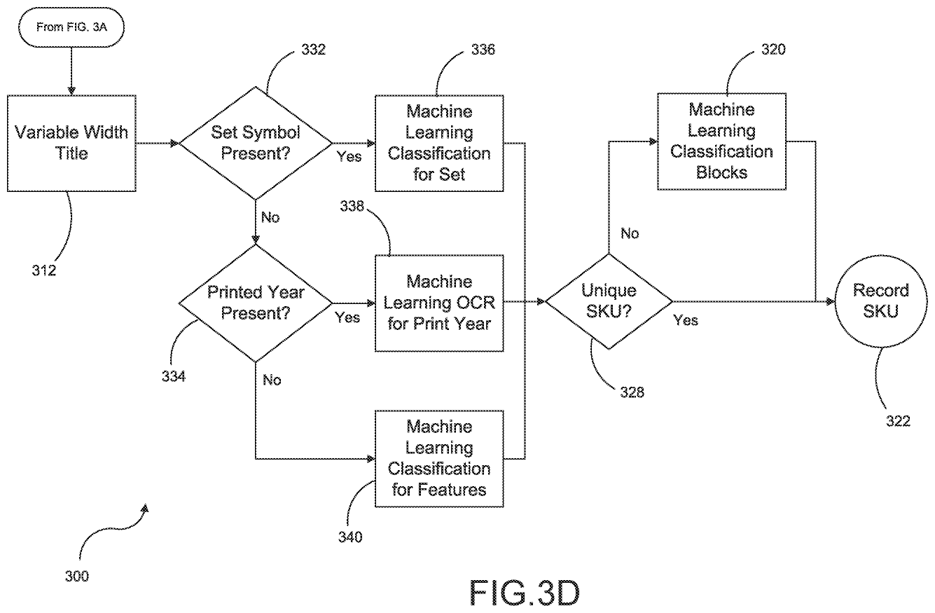

FIGS. 3A-3D are block diagrams illustrating a more detailed card classification method 300 according to another representative embodiment of the disclosed technology. Referring to FIG. 3A, the method 300 can begin by receiving image data at step 302 from an image capture device, such as image capture station 104 (FIG. 1). In some embodiments, image data can be derived from a saved image or a scan from a mobile device, for example. The images can be saved, cropped, and sized as necessary at step 302. At step 304, machine learning blocks can determine the age, border style, and card type (e.g., MTG, Pokeman, baseball), for example. At decision block 306, the card style is determined and a processing path for the image data is selected based on the card style. In this embodiment, the processing paths are determined based on whether the card style is a small run 308, a fixed width title font 310, or a variable width title 312 style card.

Referring to FIG. 3B, if the card is determined to be a small run style card (e.g., under 300 card IDs) at 308, the card is next checked whether it is an operation card having a custom printed bar code at step 314. At step 316 machine learning OCR or object detection is used to read a SKU from the bar code, which is then updated in a database at step 318. Otherwise, at step 320 machine learning classification blocks construct a unique SKU number based on characteristics of the card, such as alternate artwork, collector's numbers, and/or special stamps, to name a few. In some embodiments, the system includes one or more array tables to guide the system's determine of what features to check for on the cards. At step 322 the SKU is recorded in the database. In some embodiments, the SKU format can comprise: (Promo[P], Token[T], or Foil[F] optional)+(3 letter edition code)+“−”+(3 digit collector's number)+(variant optional). Example SKUs following this format can include:

HOU-001

THOU-001

HOU-001A

THOU-001A

Referring to FIG. 3C, if the card is determined to be a fixed width title font style card at 310, the card is checked whether it includes an OCR readable tag at step 324. If the card does include an OCR readable tag, the card's SKU is read from the tag at step 326; otherwise, the card's title is read using OCR and machine learning classification for printed sets to construct a SKU at step 330. In both cases, the card's SKU is evaluated to determine if it is unique at step 328. If the SKU is unique, the SKU is recorded at step 322; otherwise, at step 320 machine learning classification blocks construct a unique SKU number based on characteristics of the card, as discussed above with respect to FIG. 3B.

With further reference to FIG. 3D, if the card is determined to be a variable width title style card at 312, the card is checked whether it includes a set symbol at step 332. If the card does include a set symbol, a machine learning classification for set block at step 336 constructs a SKU number for the card. If the card does not include a set symbol, it is determined at step 334 whether there is a printed year present. If the card does include a printed year, a machine learning OCR for print year block at step 338 constructs a SKU number for the card; otherwise, a machine learning classification for features at step 340 constructs a SKU number for the card. In any case, the card's SKU is evaluated to determine if it is unique at step 328. If the SKU is unique, the SKU is recorded at step 322; otherwise, at step 320 machine learning classification blocks construct a unique SKU number based on characteristics of the card, as discussed above with respect to FIG. 3B.

### Suitable System

The techniques disclosed here can be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to cause a computer, a microprocessor, processor, and/or microcontroller (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

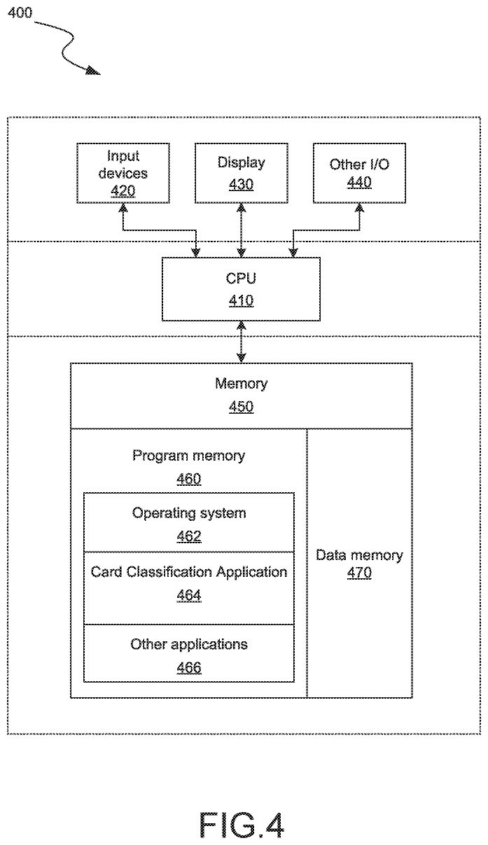

Several implementations are discussed below in more detail in reference to the figures. FIG. 4 is a block diagram illustrating an overview of devices on which some implementations of the disclosed technology can operate. The devices can comprise hardware components of a device 400 that determines which events are live and their priority based on wager information. Device 400 can include one or more input devices 420 that provide input to the CPU (processor) 410, notifying it of actions. The actions are typically mediated by a hardware controller that interprets the signals received from the input device and communicates the information to the CPU 410 using a communication protocol. Input devices 420 include, for example, a mouse, a keyboard, a touchscreen, an infrared sensor, a touchpad, a wearable input device, a camera- or image-based input device, a microphone, or other user input devices.

CPU 410 can be a single processing unit or multiple processing units in a device or distributed across multiple devices. CPU 410 can be coupled to other hardware devices, for example, with the use of a bus, such as a PCI bus or SCSI bus. The CPU 410 can communicate with a hardware controller for devices, such as for a display 430. Display 430 can be used to display text and graphics. In some examples, display 430 provides graphical and textual visual feedback to a user. In some implementations, display 430 includes the input device as part of the display, such as when the input device is a touchscreen or is equipped with an eye direction monitoring system. In some implementations, the display is separate from the input device. Examples of display devices are: televisions; mobile devices; an LCD display screen; an LED display screen; a projected, holographic, or augmented reality display (such as a heads-up display device or a head-mounted device); and so on. Other I/O devices 440 can also be coupled to the processor, such as a network card, video card, audio card, USB, FireWire or other external device, camera, printer, speakers, CD-ROM drive, DVD drive, disk drive, or Blu-Ray device.

In some implementations, the device 400 also includes a communication device capable of communicating wirelessly or wire-based with a network node. The communication device can communicate with another device or a server through a network using, for example, TCP/IP protocols. Device 400 can utilize the communication device to distribute operations across multiple network devices.

The CPU 410 can have access to a memory 450. A memory includes one or more of various hardware devices for volatile and non-volatile storage, and can include both read-only and writable memory. For example, a memory can comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory is not a propagating signal divorced from underlying hardware; a memory is thus non-transitory. Memory 450 can include program memory 460 that stores programs and software, such as an operating system 462, a card classification application 464, and other application programs 466. Memory 450 can also include data memory 470 that can include SKU information and classification information, etc., which can be provided to the program memory 460 or any element of the device 400.

Some implementations can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, mobile phones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

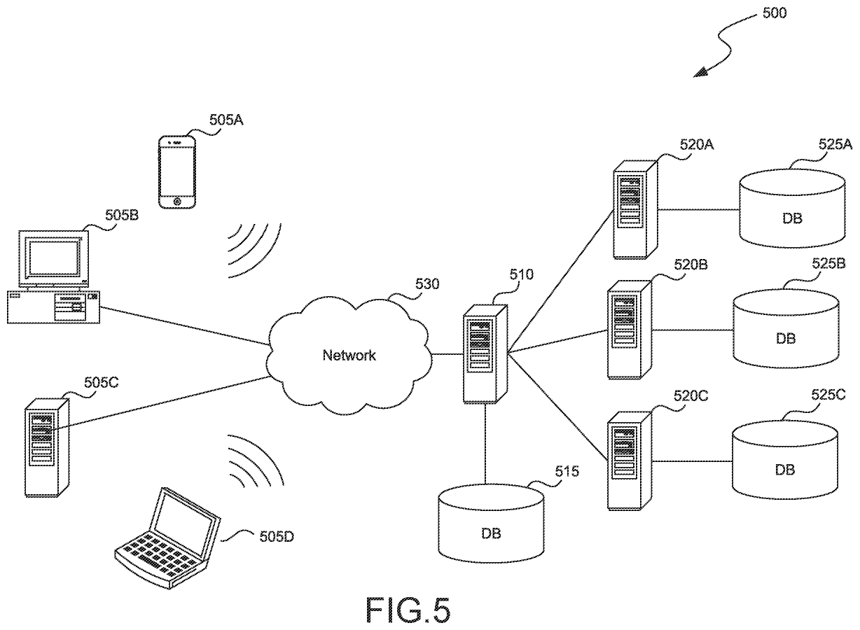

FIG. 5 is a block diagram illustrating an overview of an environment 500 in which some implementations of the disclosed technology can operate. Environment 500 can include one or more client computing devices 505A-D, examples of which can include device 400. Client computing devices 505 can operate in a networked environment using logical connections through network 530 to one or more remote computers, such as a server computing device 510.

In some implementations, server computing device 510 can be an edge server that receives client requests and coordinates fulfillment of those requests through other servers, such as servers 520A-C. Server computing devices 510 and 520 can comprise computing systems, such as device 400. Though each server computing device 510 and 520 is displayed logically as a single server, server computing devices can each be a distributed computing environment encompassing multiple computing devices located at the same or at geographically disparate physical locations. In some implementations, each server computing device 520 corresponds to a group of servers.

Client computing devices 505 and server computing devices 510 and 520 can each act as a server or client to other server/client devices. Server 510 can connect to a database 515. Servers 520A-C can each connect to a corresponding database 525A-C. As discussed above, each server 520 can correspond to a group of servers, and each of these servers can share a database or can have their own database. Databases 515 and 525 can warehouse (e.g., store) information such as selected card features, card values, SKU numbers, variability of card features, and/or user preferences. Though databases 515 and 525 are displayed logically as single units, databases 515 and 525 can each be a distributed computing environment encompassing multiple computing devices, can be located within their corresponding server, or can be located at the same or at geographically disparate physical locations.

Network 530 can be a local area network (LAN) or a wide area network (WAN), but can also be other wired or wireless networks. Network 530 may be the Internet or some other public or private network. Client computing devices 505 can be connected to network 530 through a network interface, such as by wired or wireless communication. While the connections between server 510 and servers 520 are shown as separate connections, these connections can be any kind of local, wide area, wired, or wireless network, including network 530 or a separate public or private network.

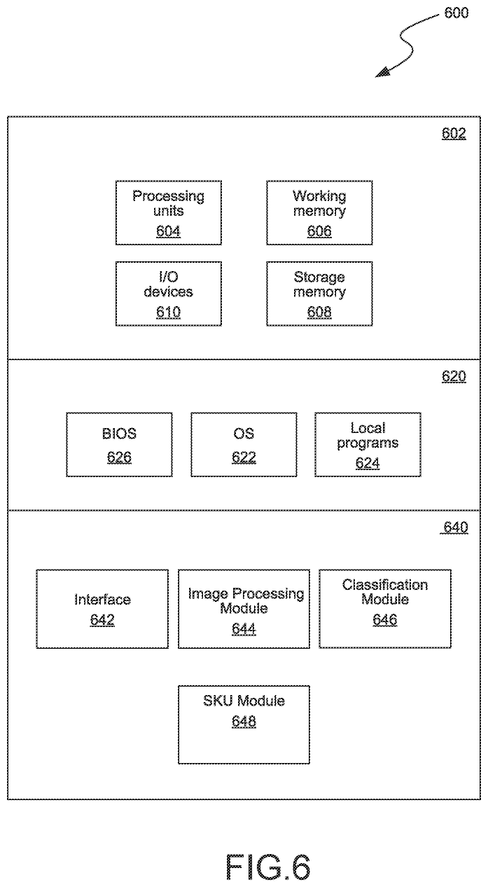

FIG. 6 is a block diagram illustrating components 600 which, in some implementations, can be used in a system employing the disclosed technology. The components 600 include hardware 602, general software 620, and specialized components 640. As discussed herein, a system implementing the disclosed technology can use various hardware, including processing units 604 (e.g., CPUs, GPUs, APUs, etc.), working memory 606, storage memory 608, and input and output devices 610. Components 600 can be implemented in a client computing device such as client computing devices 505 or on a server computing device, such as server computing device 510 or 520.

General software 620 can include various applications, including an operating system 622, local programs 624, and a basic input output system (BIOS) 626. Specialized components 640 can be subcomponents of a general software application 620, such as local programs 624. Specialized components 640 can include an Image Processing Module 644, Classification Module 646, SKU Module 648, and components that can be used for transferring data and controlling the specialized components, such as interface 642. In some implementations, components 600 can be in a computing system that is distributed across multiple computing devices or can be an interface to a server-based application executing one or more of specialized components 640.

Those skilled in the art will appreciate that the components illustrated in FIGS. 4-6 described above, and in each of the flow diagrams discussed above, may be altered in a variety of ways. For example, the order of the logic may be rearranged, sub steps may be performed in parallel, illustrated logic may be omitted, other logic may be included, etc. In some implementations, one or more of the components described above can execute one or more of the processes described below.

### Representative Neural Network Structure and Examples

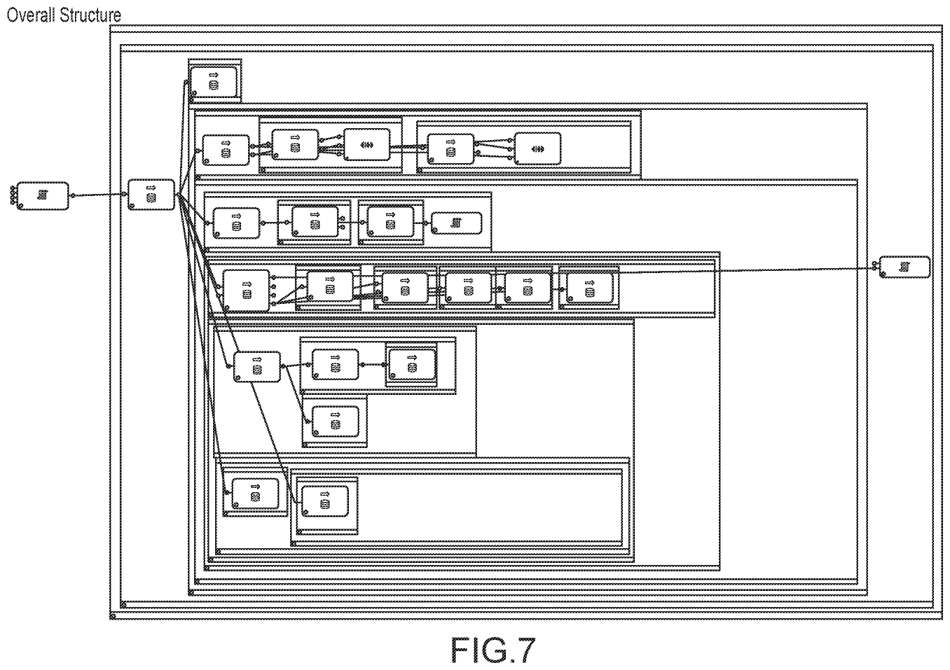

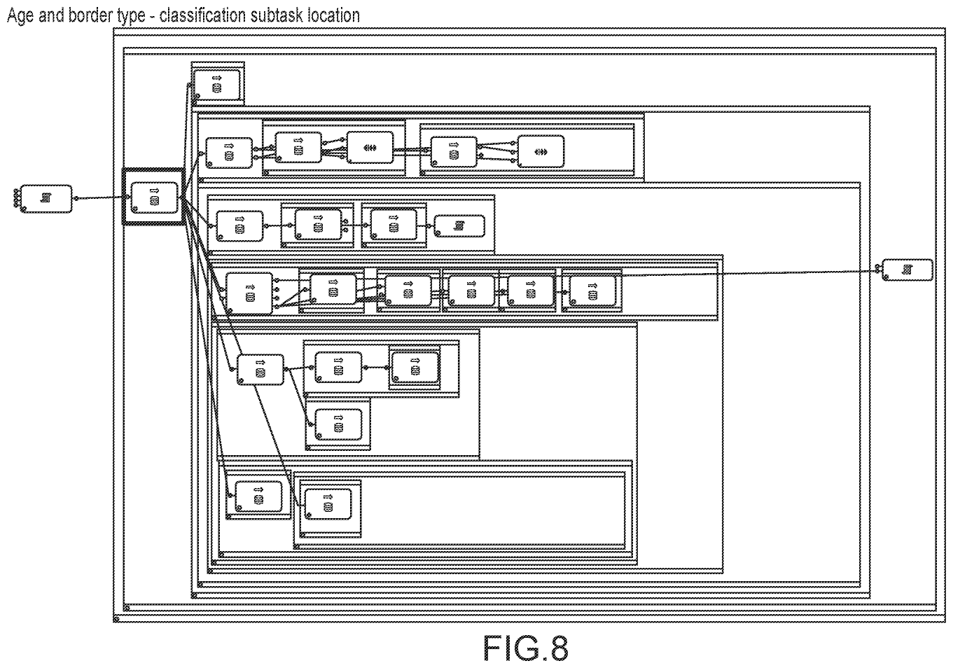

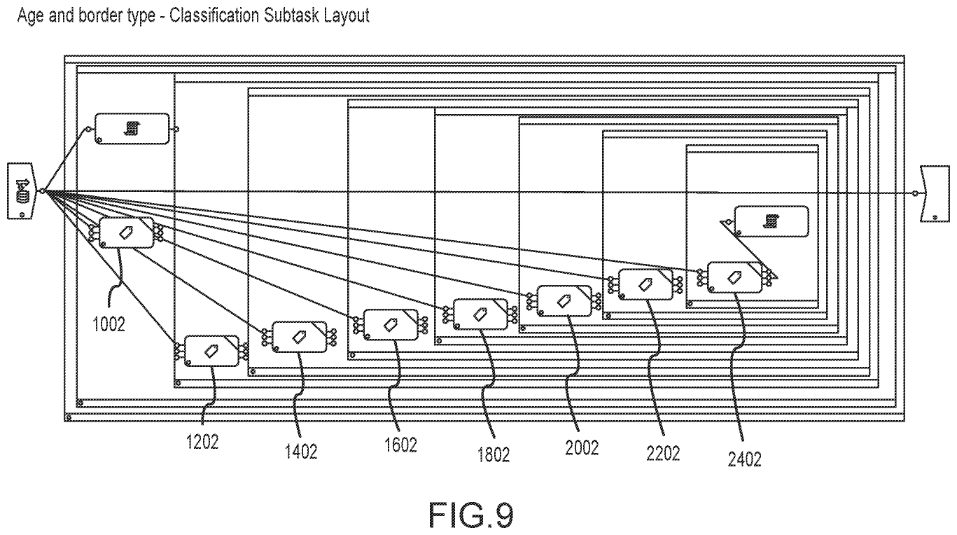

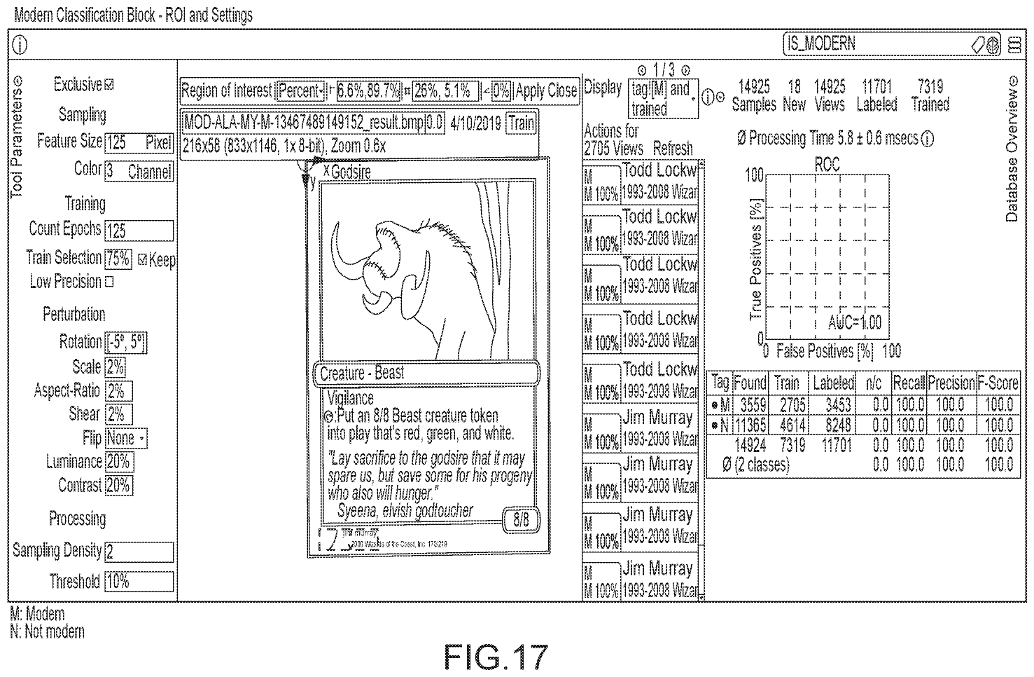

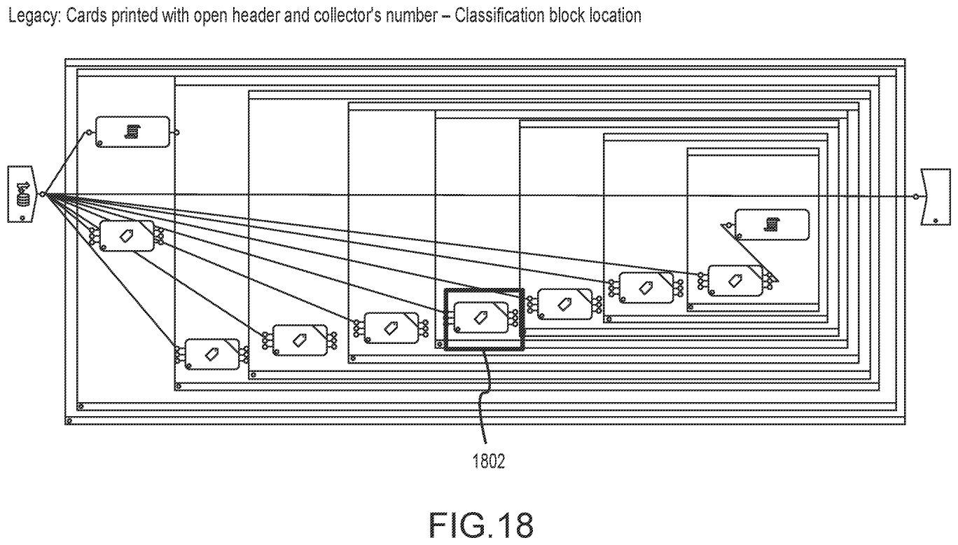

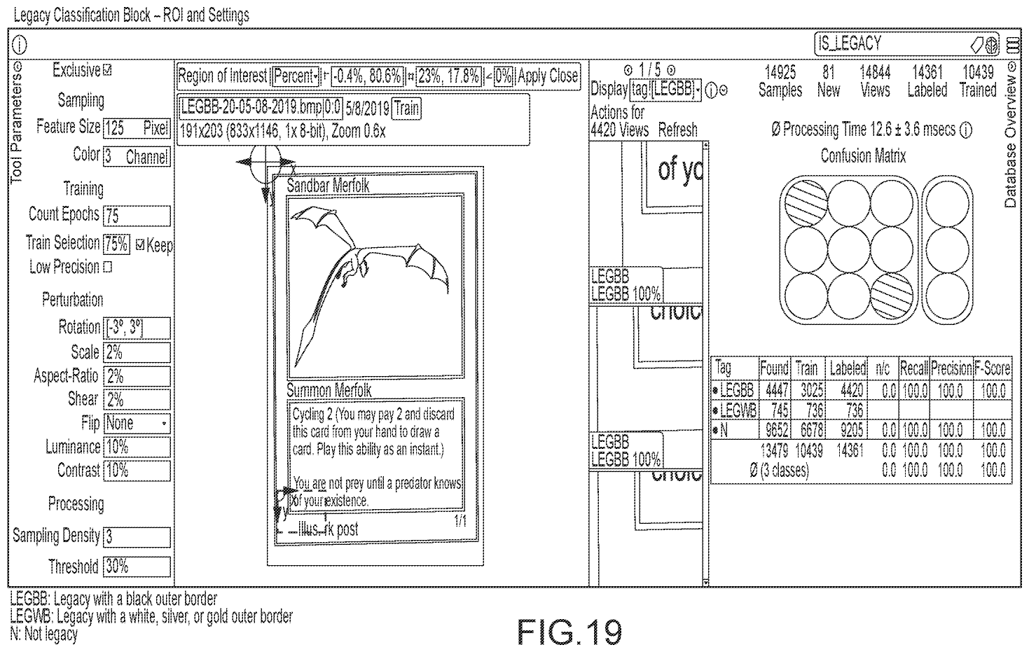

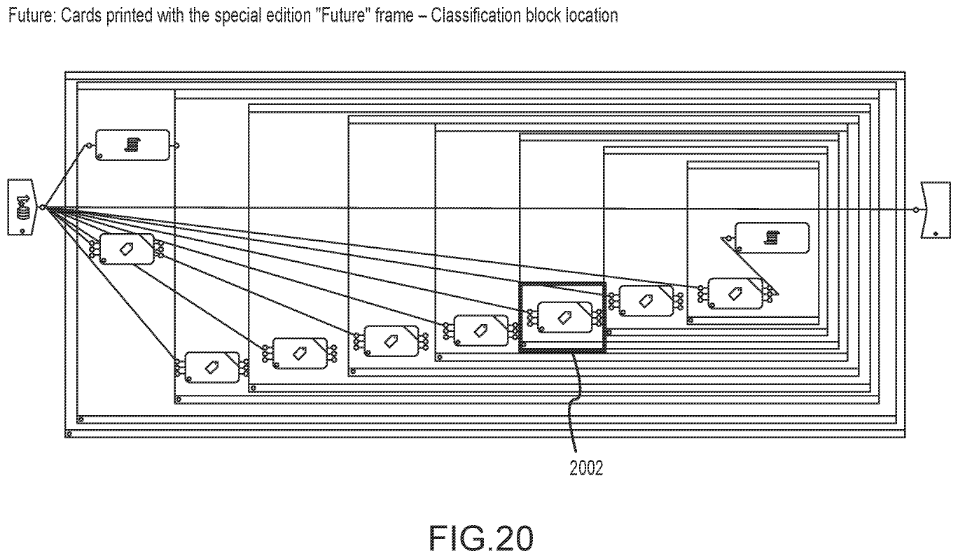

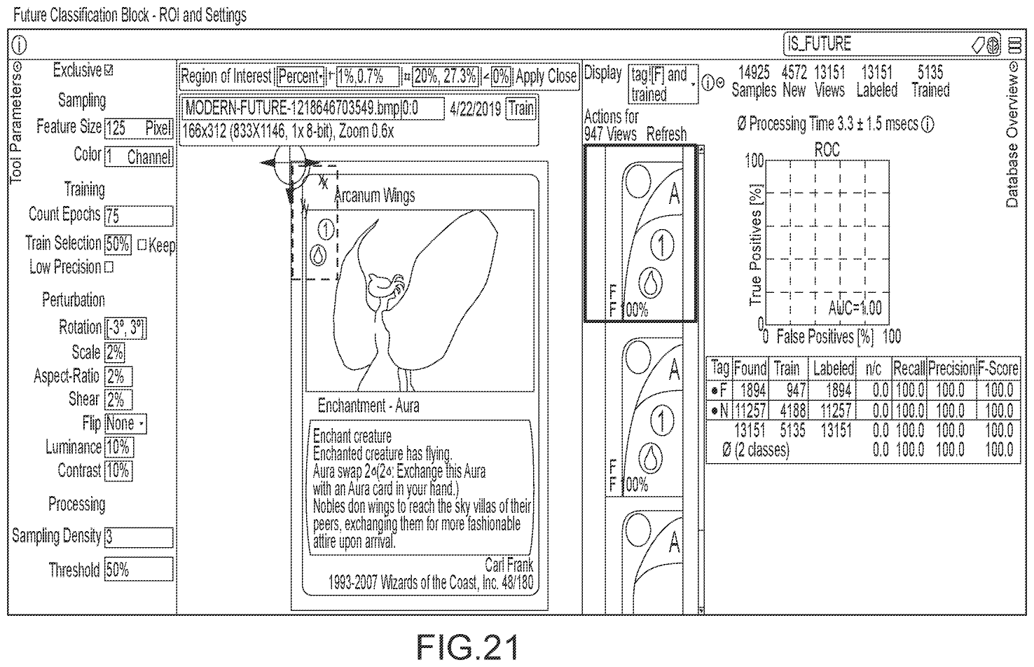

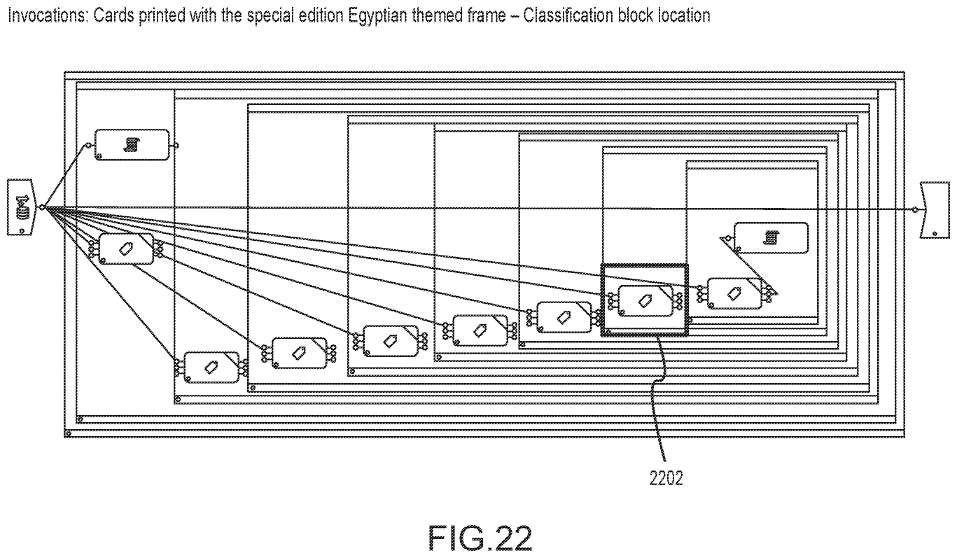

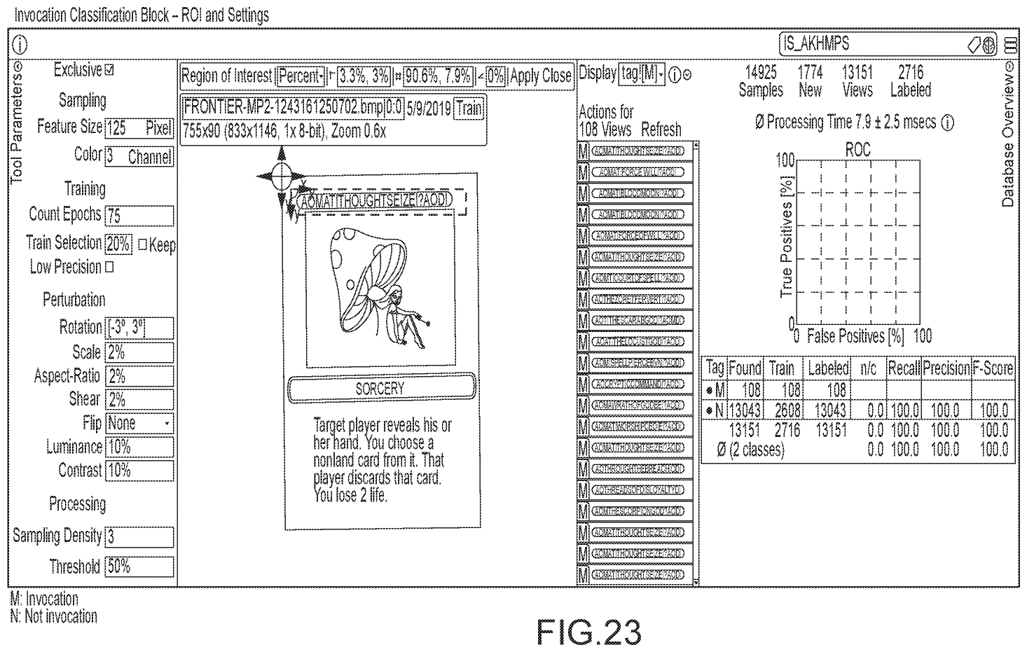

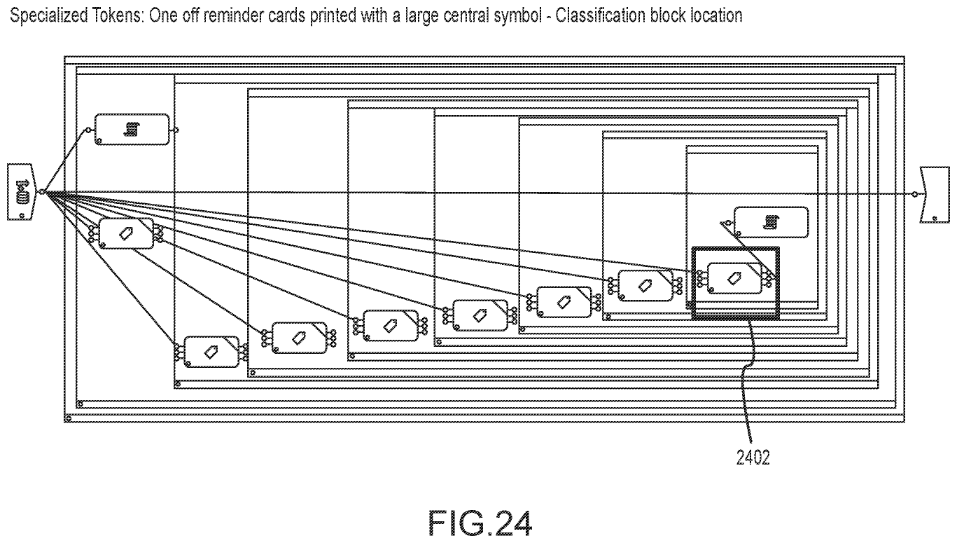

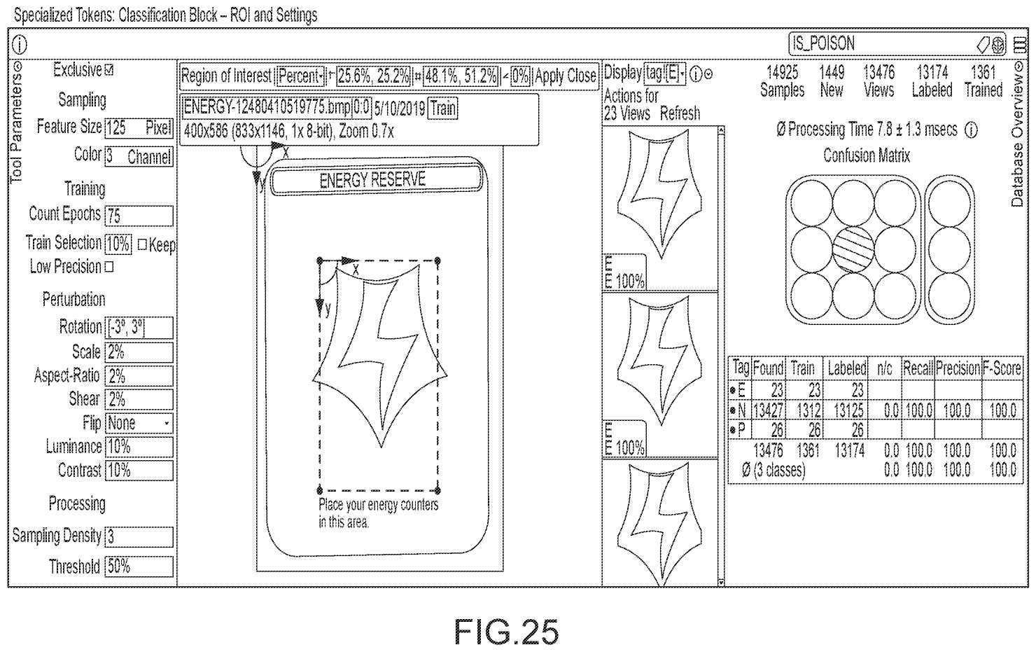

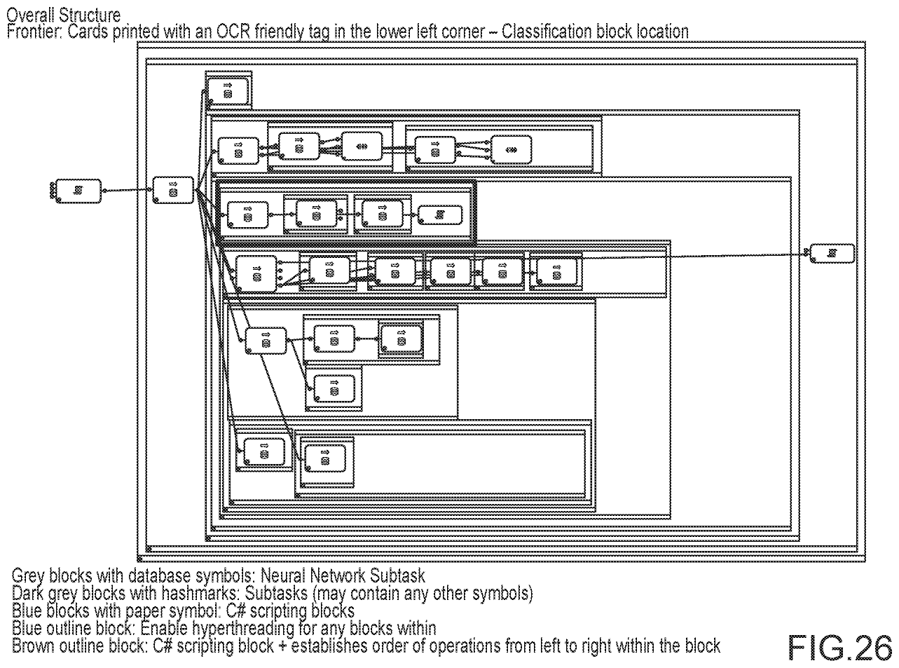

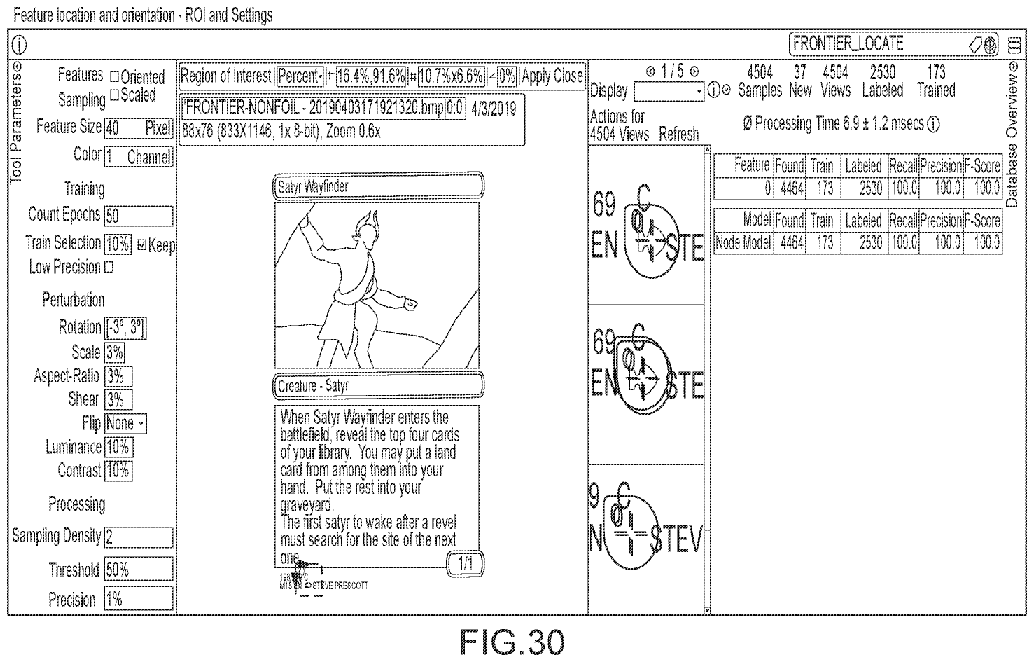

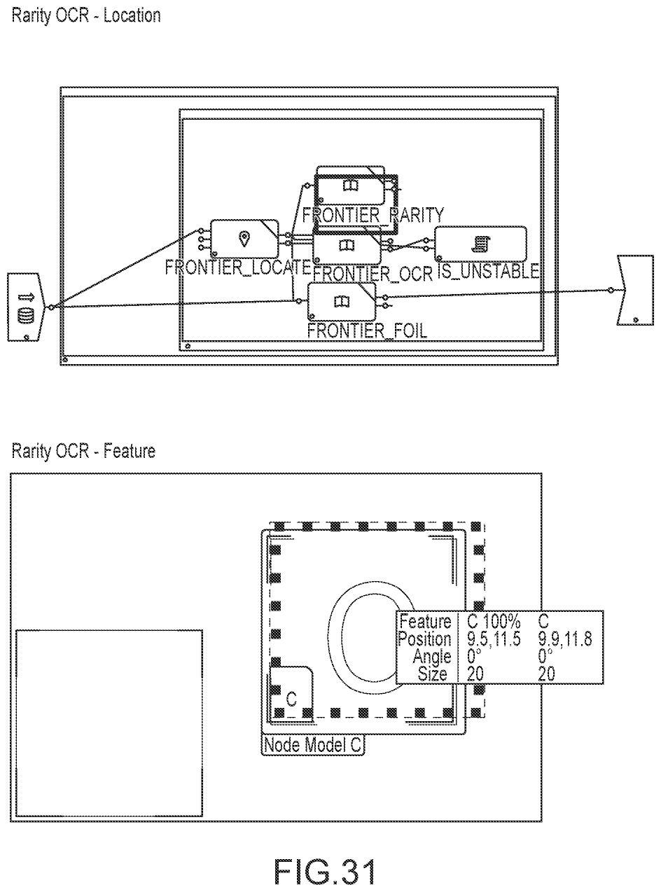

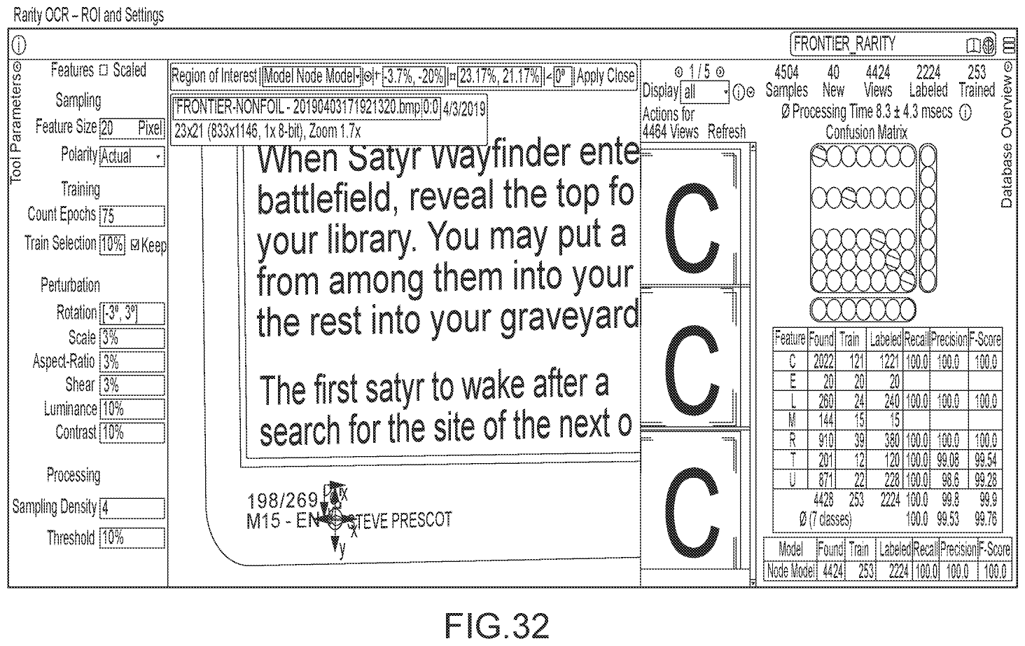

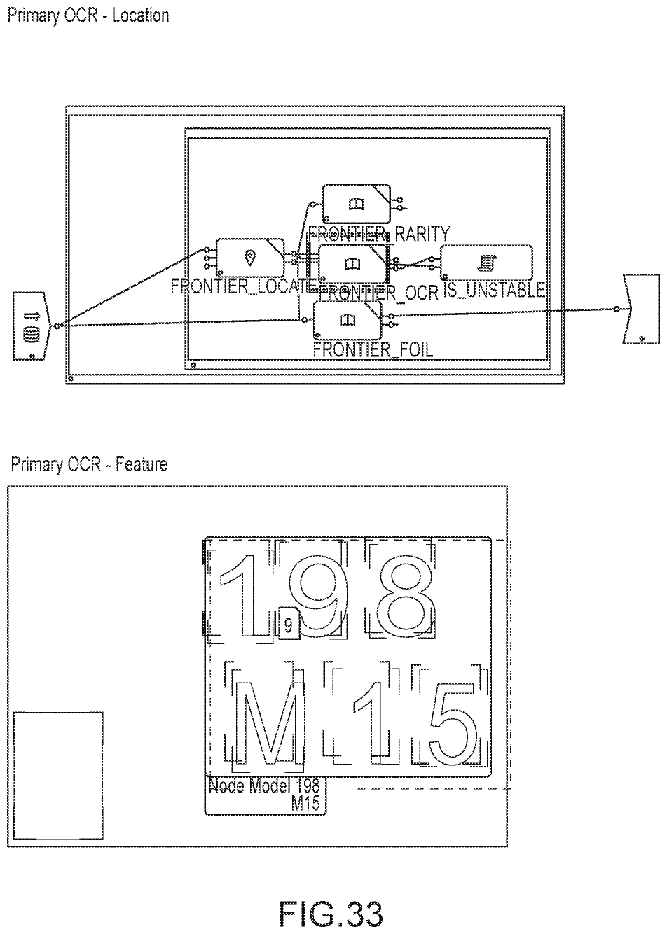

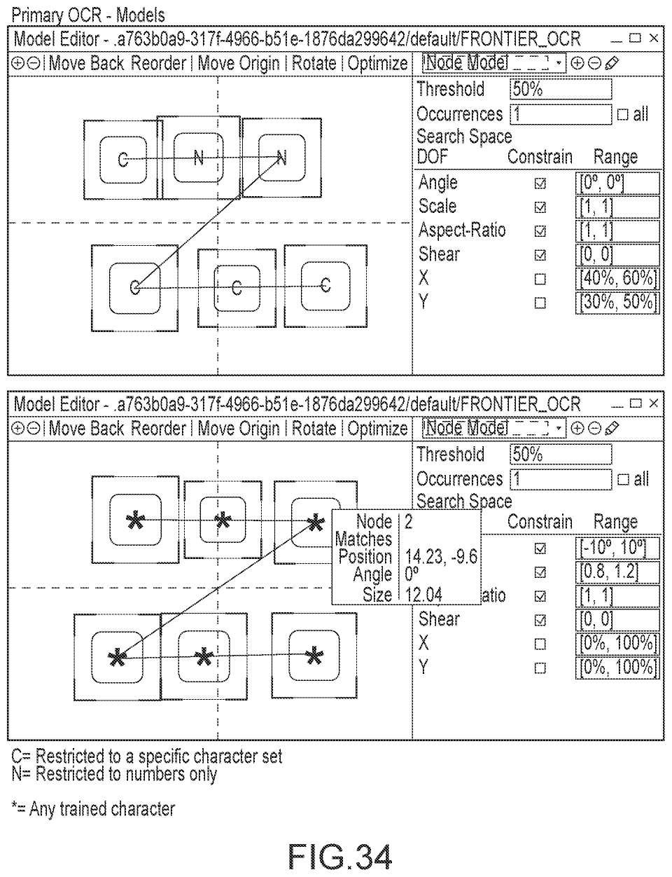

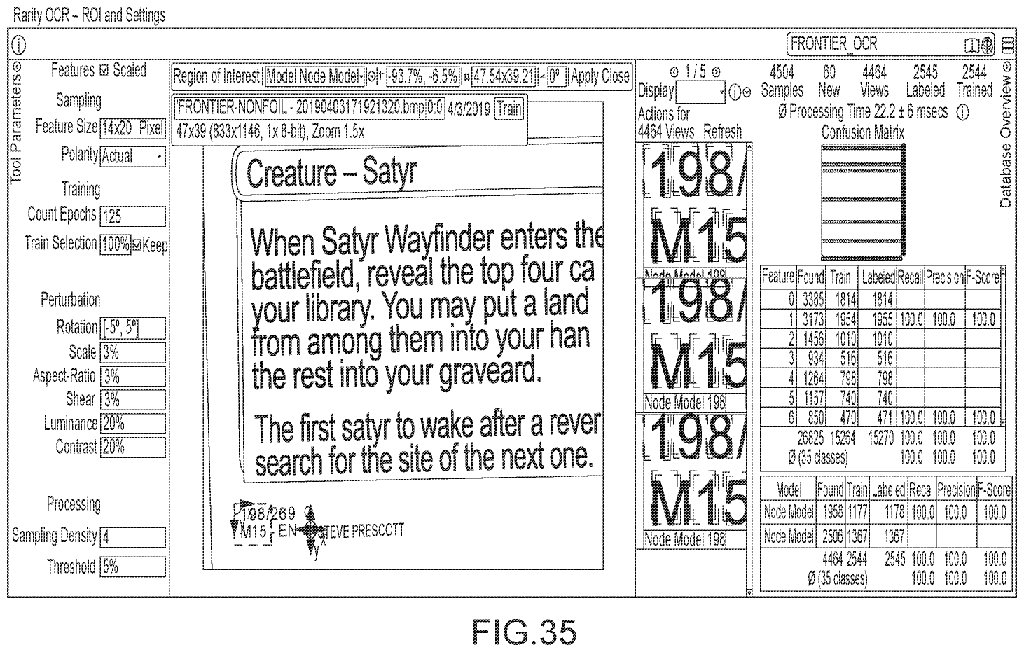

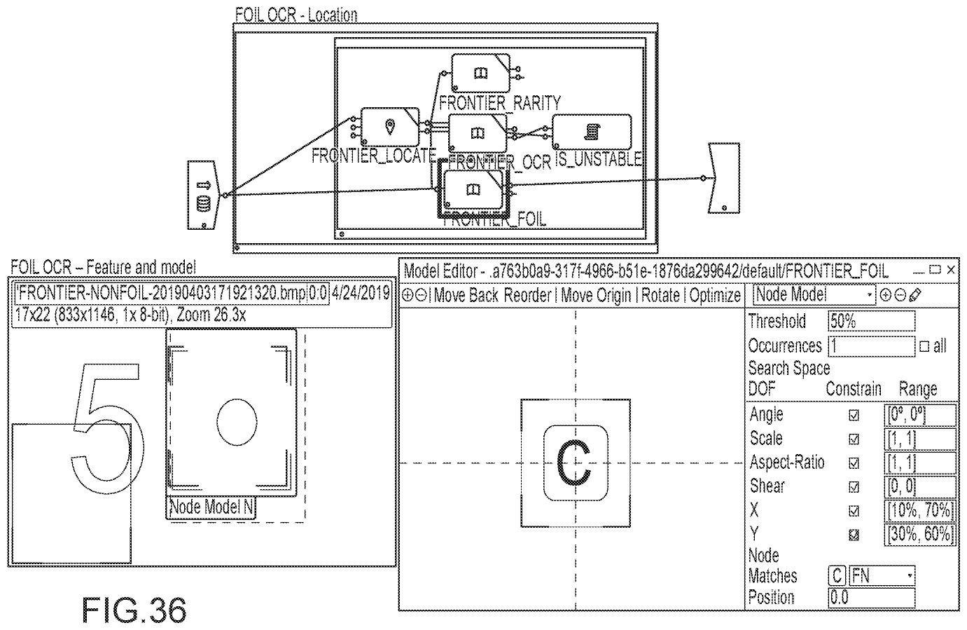

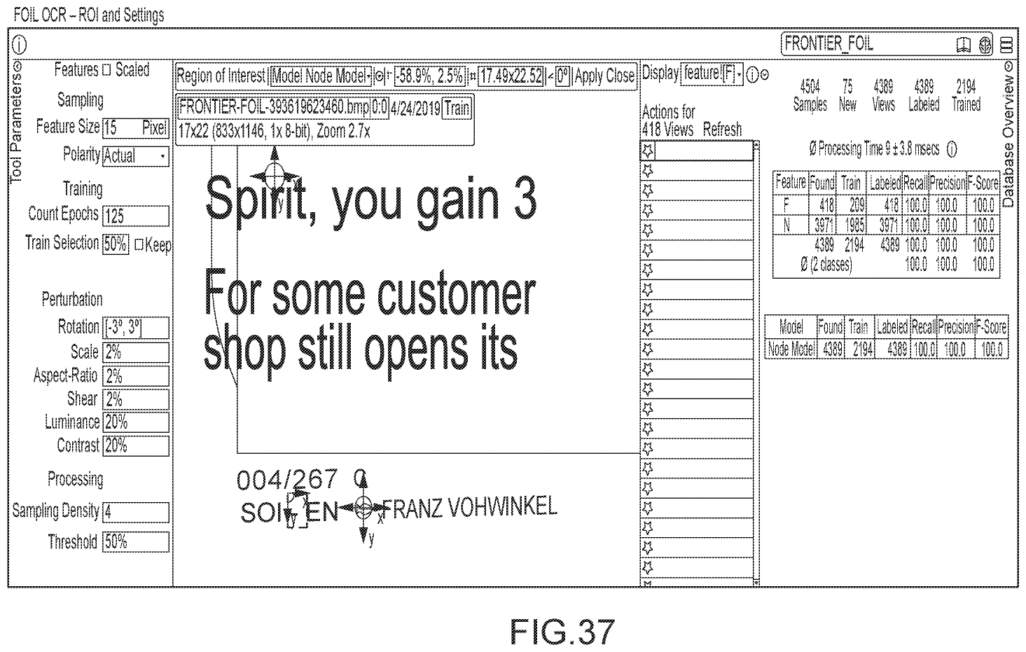

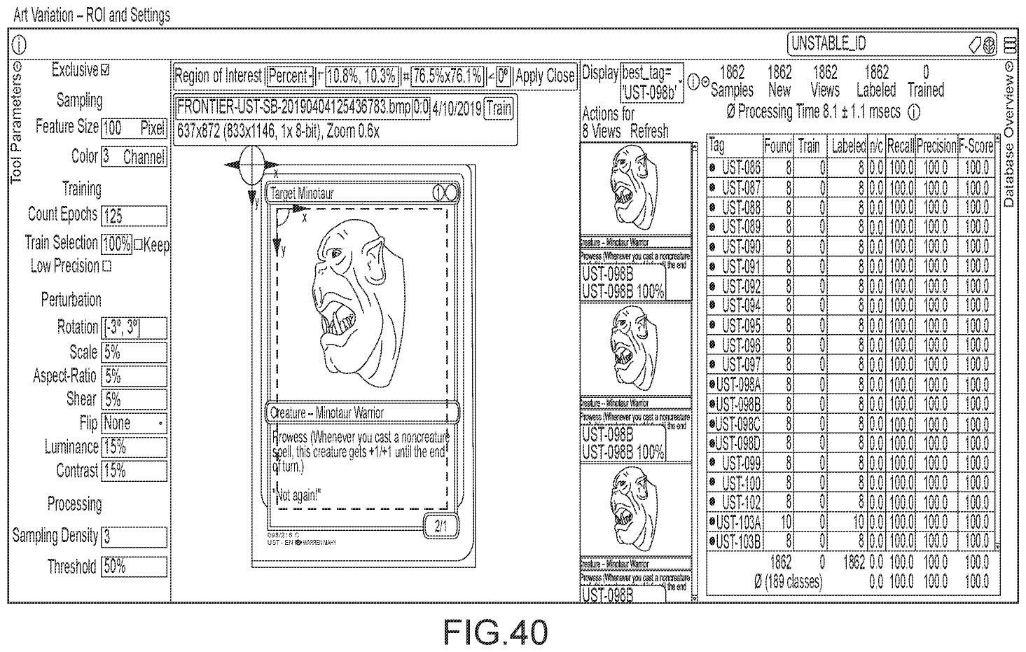

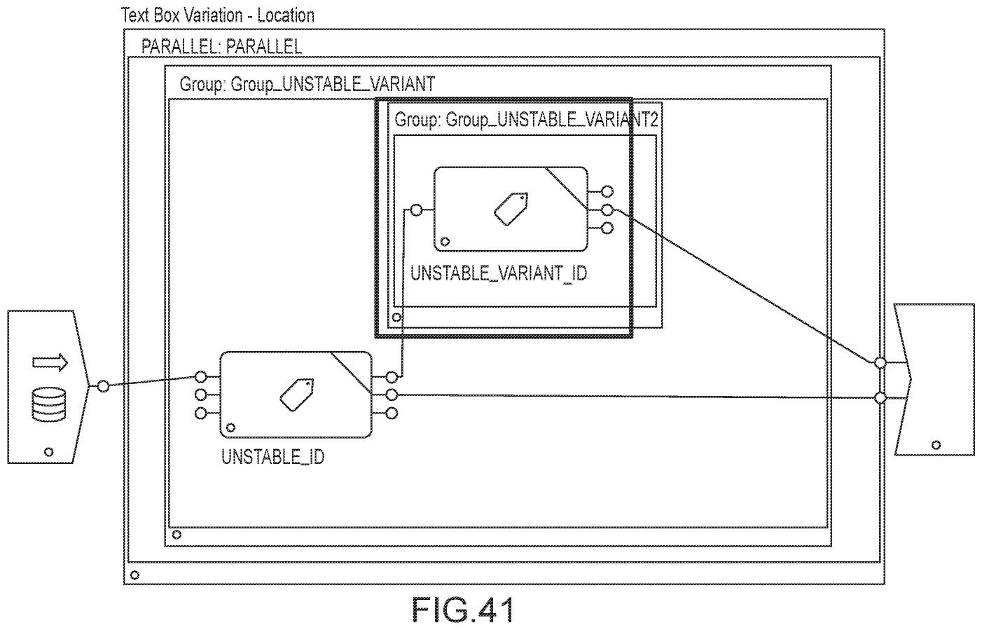

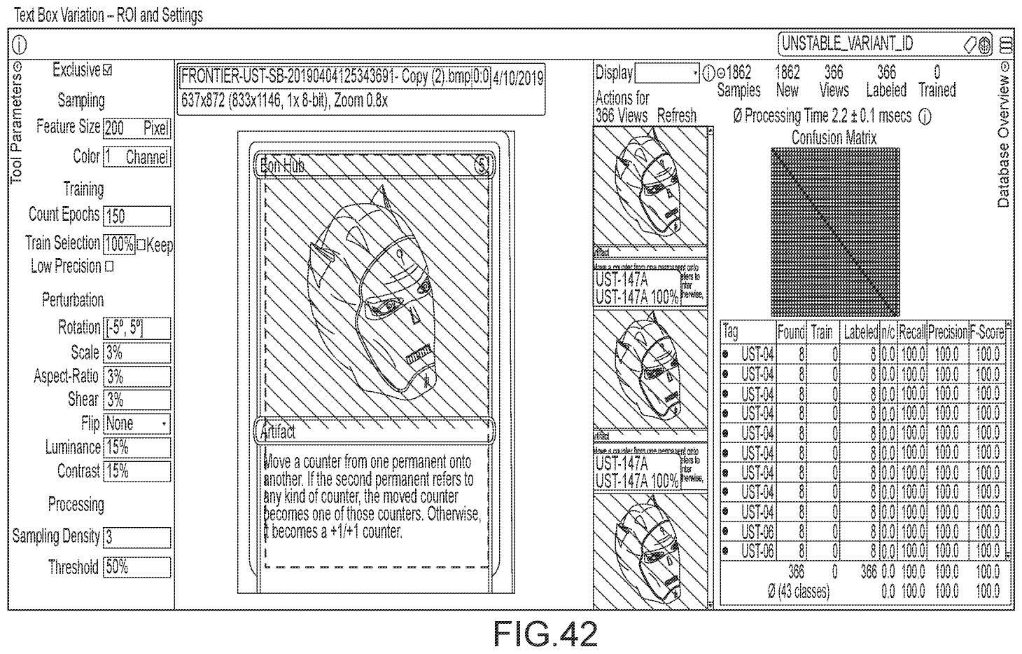

Having described particular collectable card classification systems and methods, representative neural network structures and exemplary depictions of actual MTG cards with highlighted classification features are provided. FIGS. 7-25 provide example neural network structures for determining MTG card styles, namely meta-tag 1002, vintage 1202, frontier 1402, modern 1602, legacy 1802, future 2002, invocations 2202, and specialized token 2402 styles. FIGS. 26-47 provide example neural network structures for providing a final classification for frontier style cards. In the depicted network structures grey blocks with database symbols represent Neural Network Subtasks; dark grey blocks with hashmarks represent Subtasks (may contain any other symbols); blue blocks with paper symbol represent C# scripting blocks; blue outline blocks represent Enable hyperthreading for any blocks within; and brown outline blocks represent C# scripting block+establishes order of operations from left to right within the block.

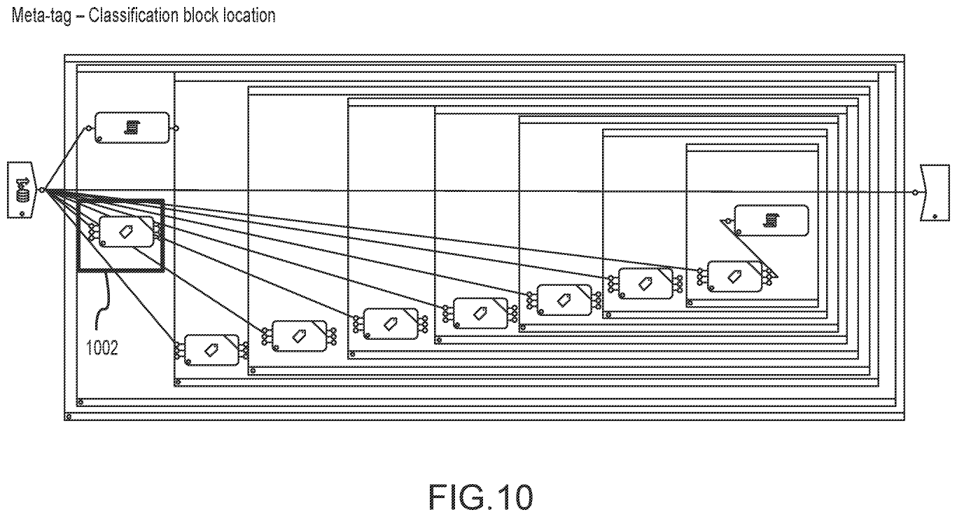

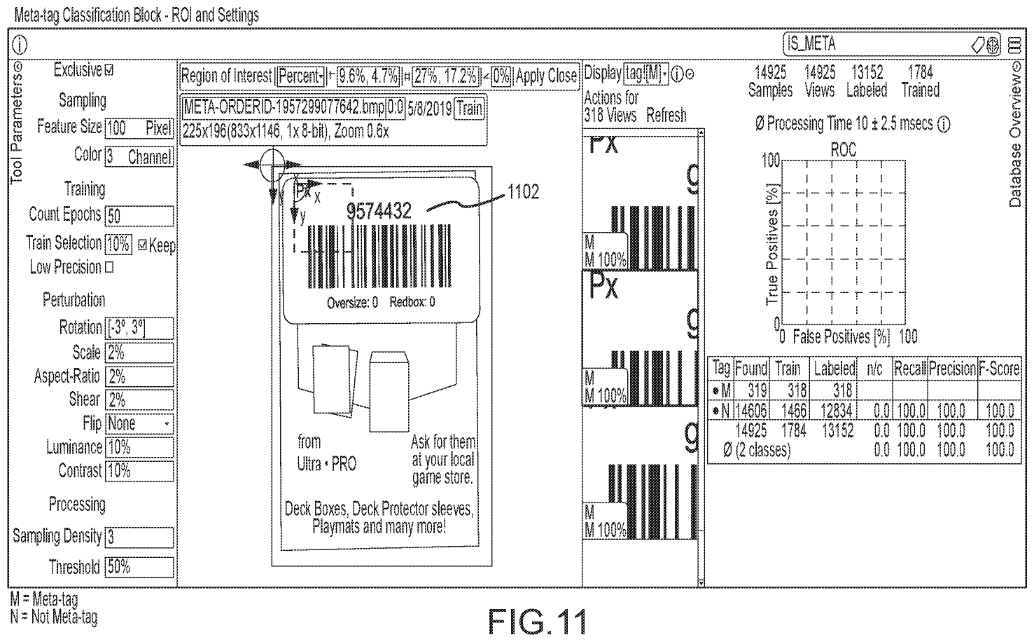

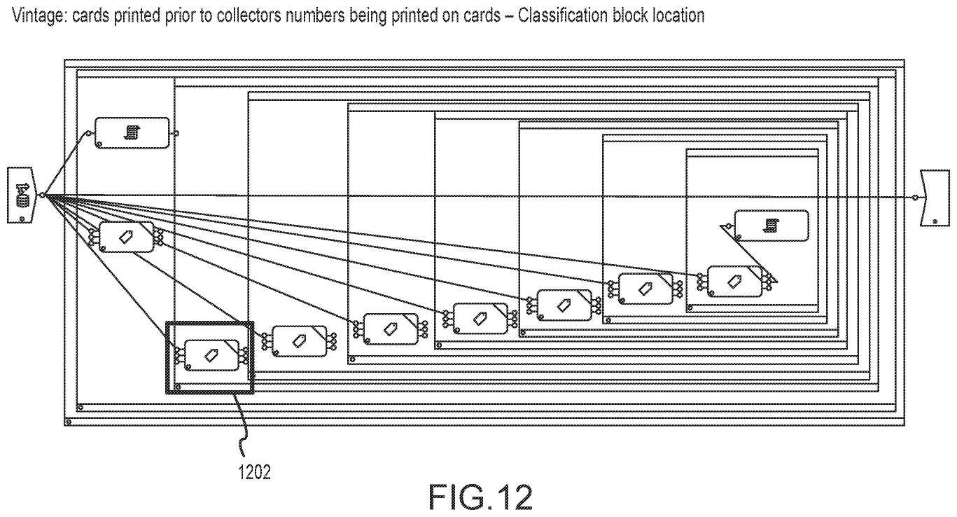

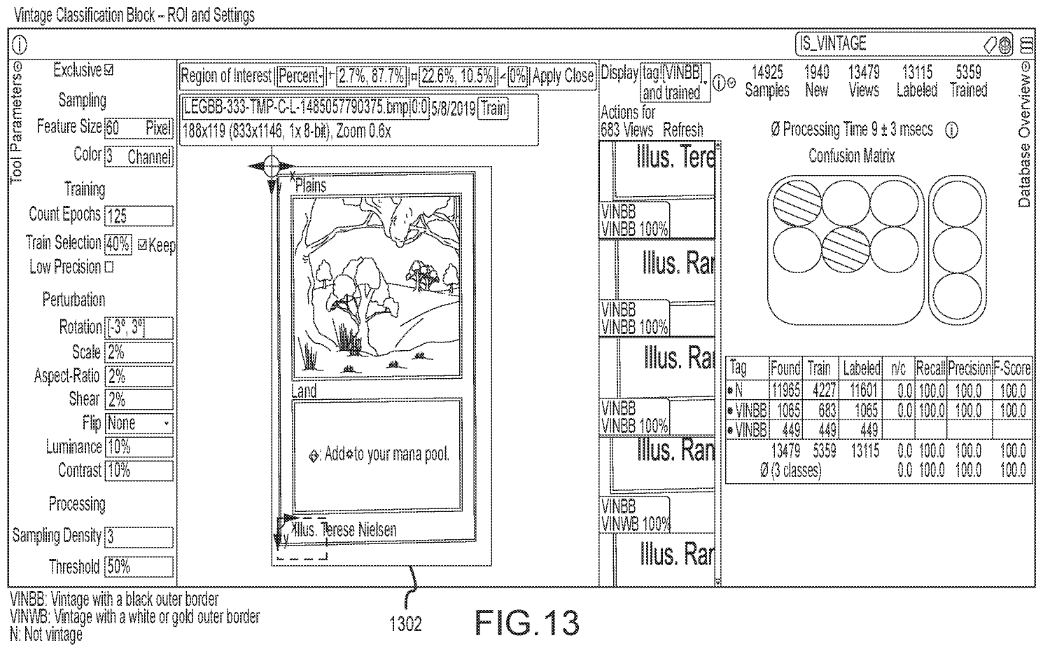

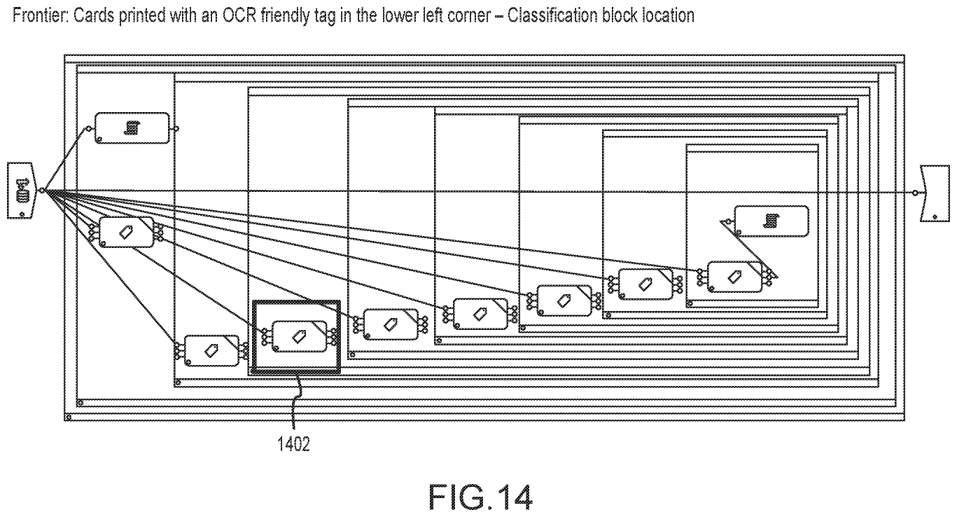

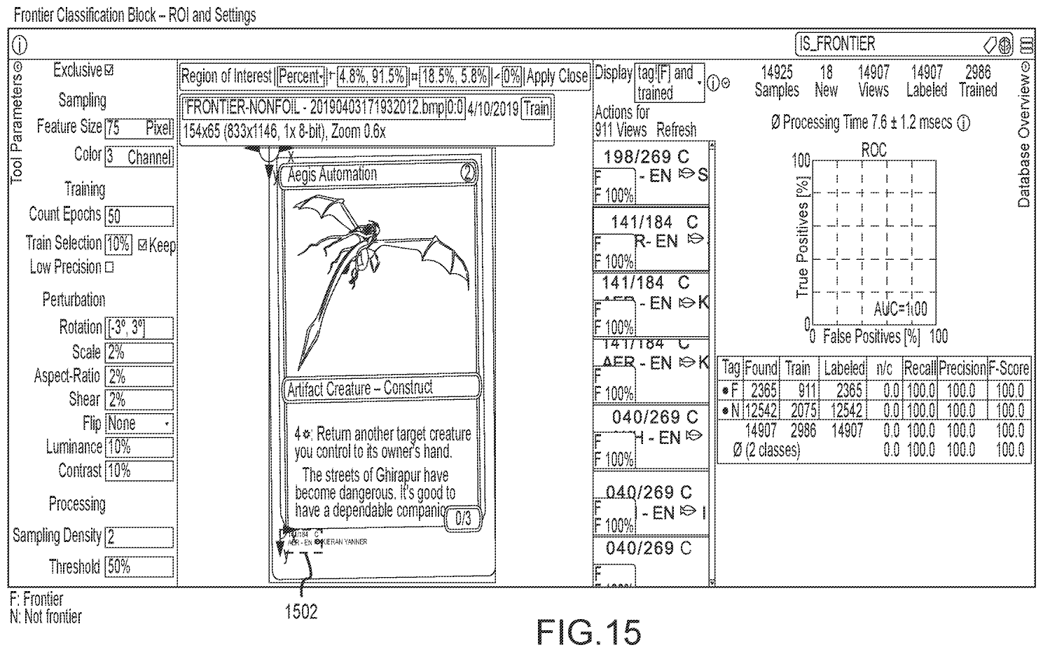

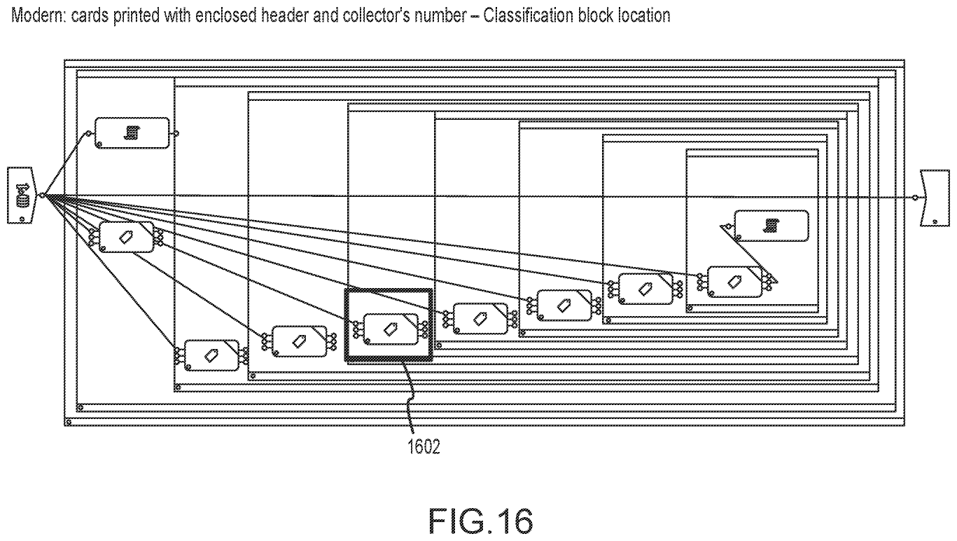

FIGS. 7-9 illustrate the overall structure and classification subtask of a MTG card style classification network according to a representative embodiment. FIG. 10 illustrates the classification block 1002 for evaluating if a card is a meta-tag style card. As shown in FIG. 11, this card style is meta-tag as it includes a bar-code label 1102. Moving to FIG. 12, the classification block 1202 for evaluating if a card is a vintage style card is illustrated. The card shown in FIG. 13 is a vintage style card because it does not have a collector's number and includes a black outer border 1302. FIG. 14 illustrates the classification block 1402 for evaluating if a card is a frontier style card. As shown in FIG. 15, this card style is frontier as it includes an OCR friendly tag 1502 in the lower left corner. The modern 1602, legacy 1802, future 2002, invocations 2202, and specialized token 2402 style cards are similarly identified using various features of those styles of cards as illustrated in FIGS. 16-25.

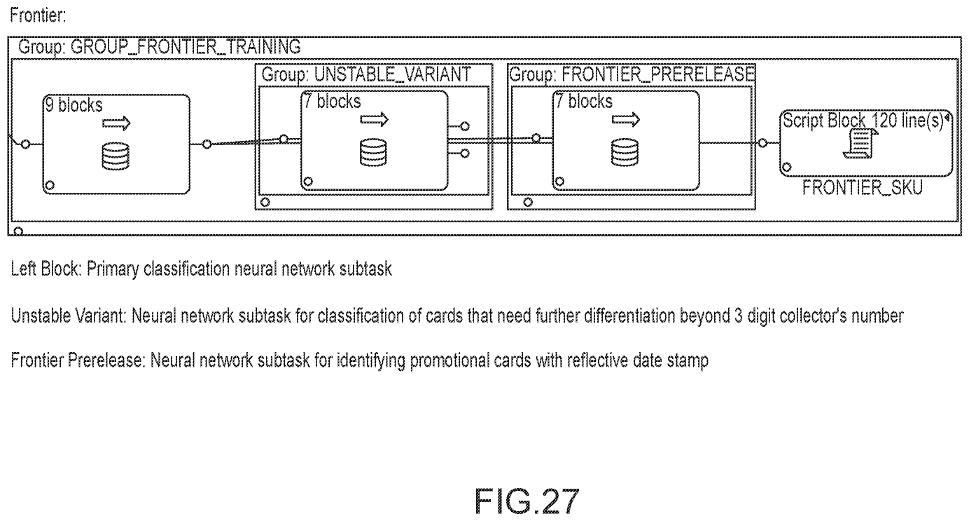

FIG. 26 illustrates a representative overall structure for final classification of each particular card style. For example, as shown in FIG. 27, the frontier style final classification subtask includes a primary classification neural network subtask; an unstable variant neural network subtask for classification of cards that need further differentiation beyond a three digit collector's number; and a frontier prerelease neural network subtask for identifying promotional cards with reflective date stamps. Although the specific structure for and details for classifying each of the other MTG card styles discussed above are not described herein, their structures and the techniques used to identify and classify characteristic features of those styles is similar to that described herein with respect to the frontier style cards.

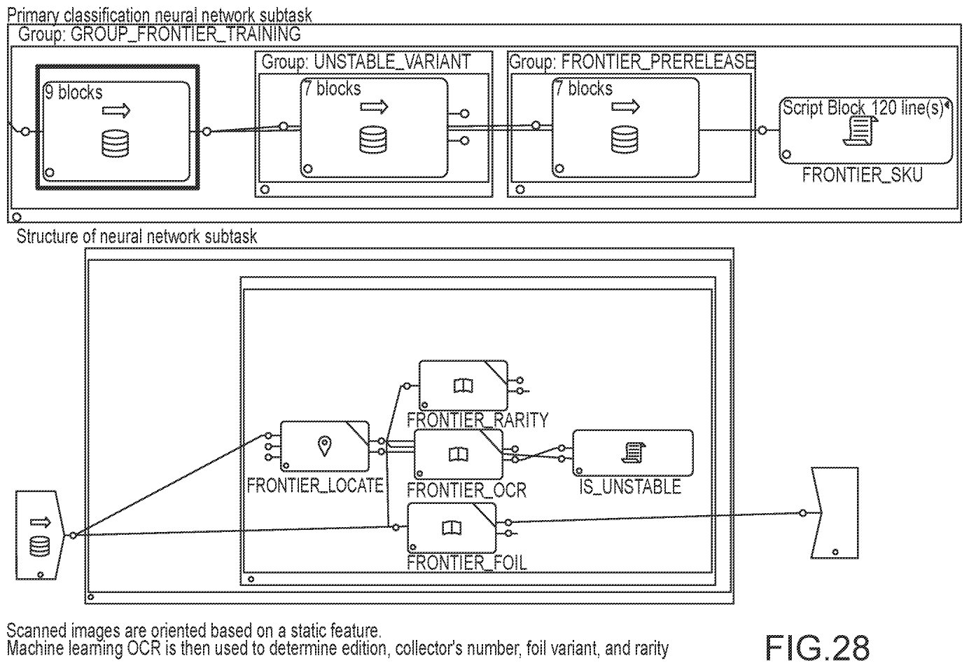

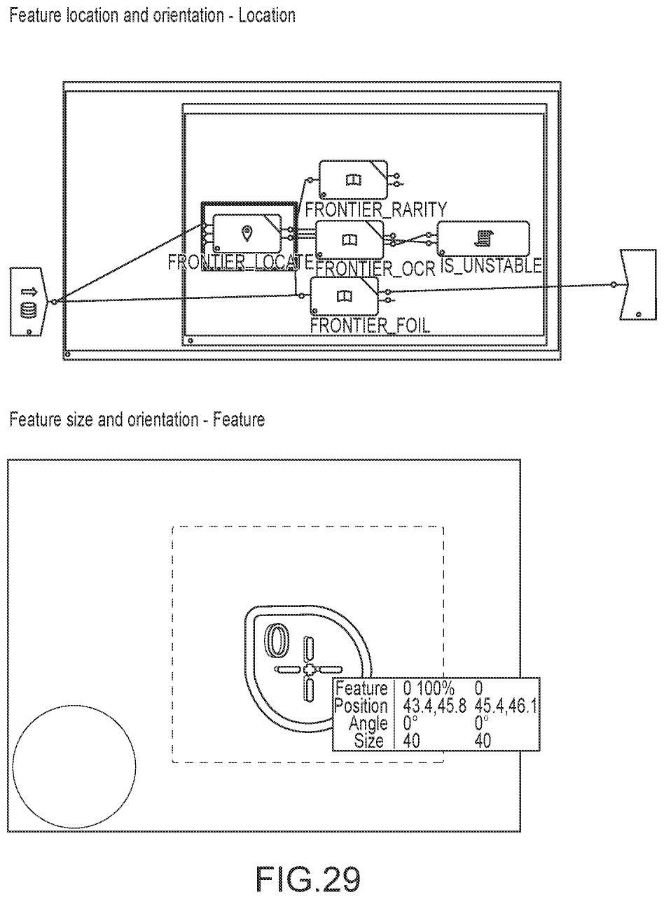

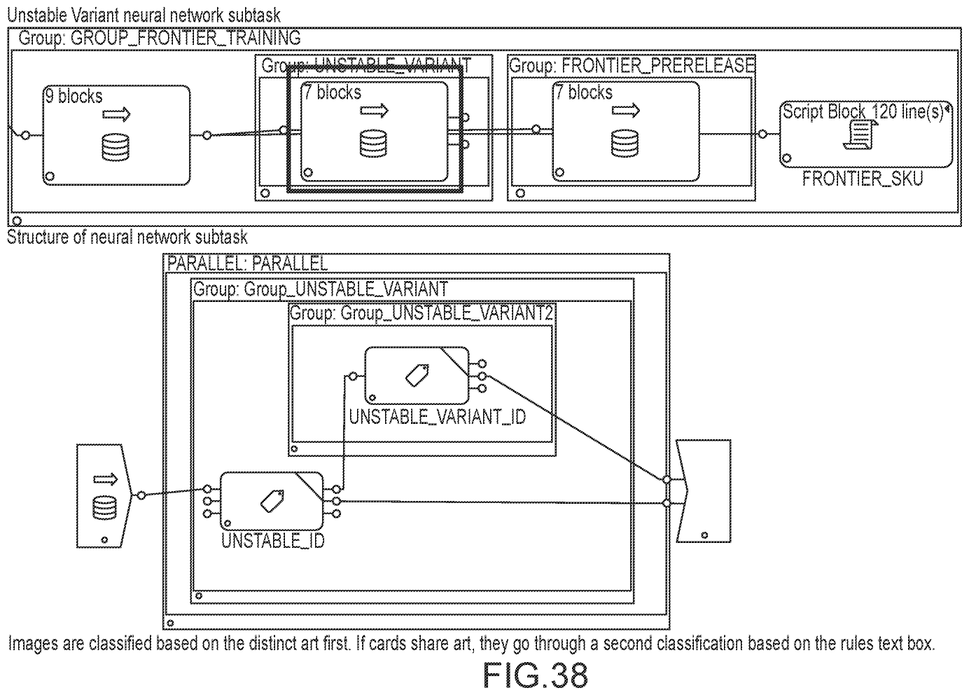

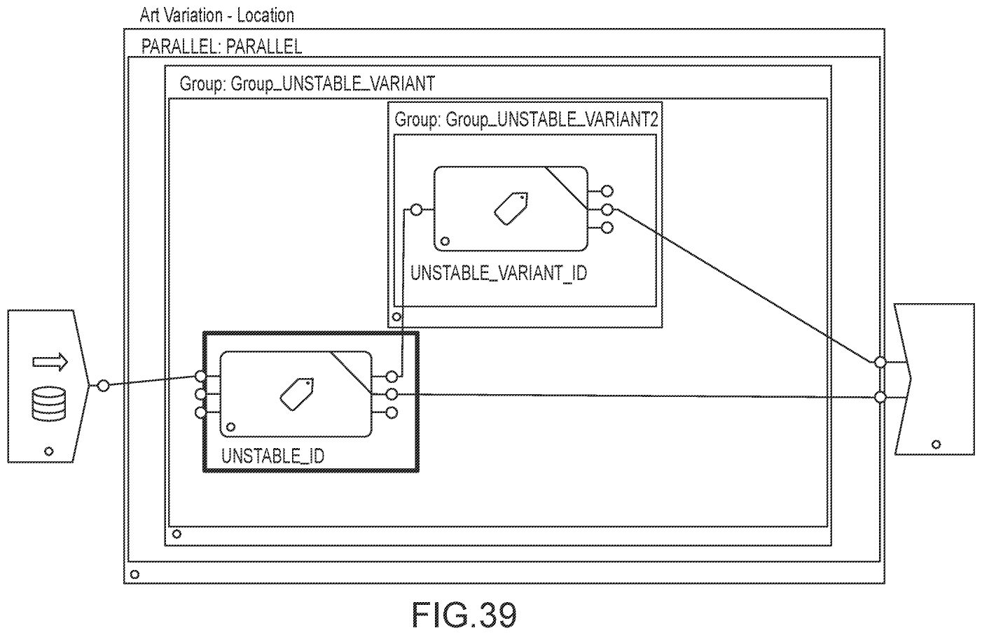

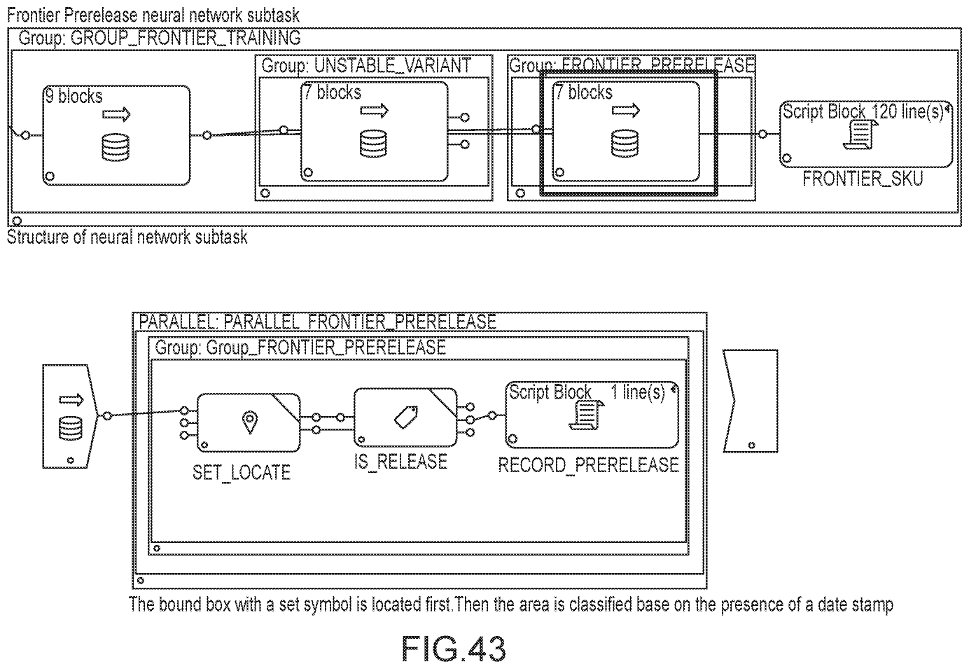

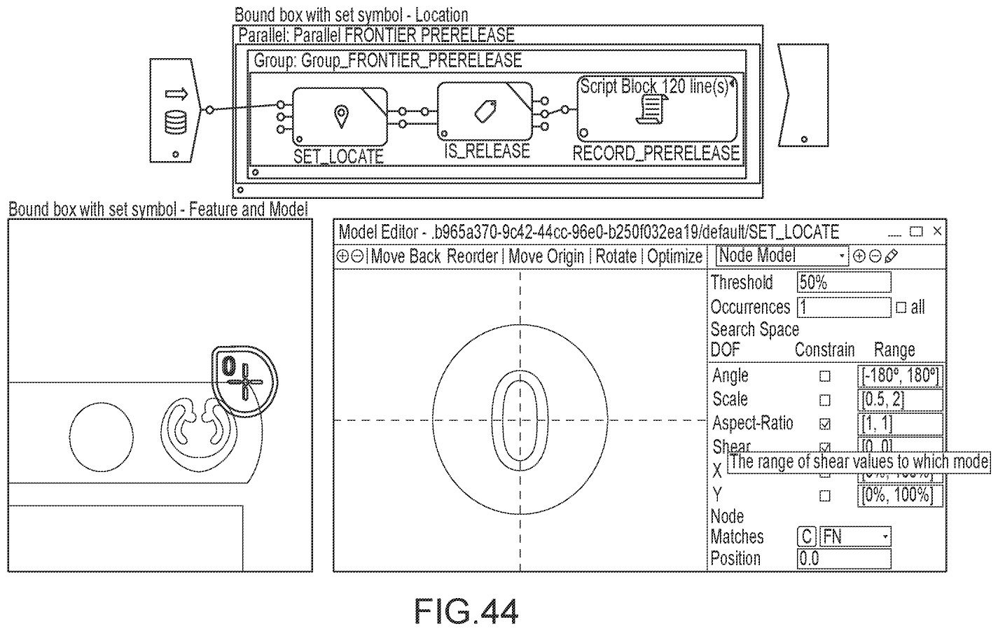

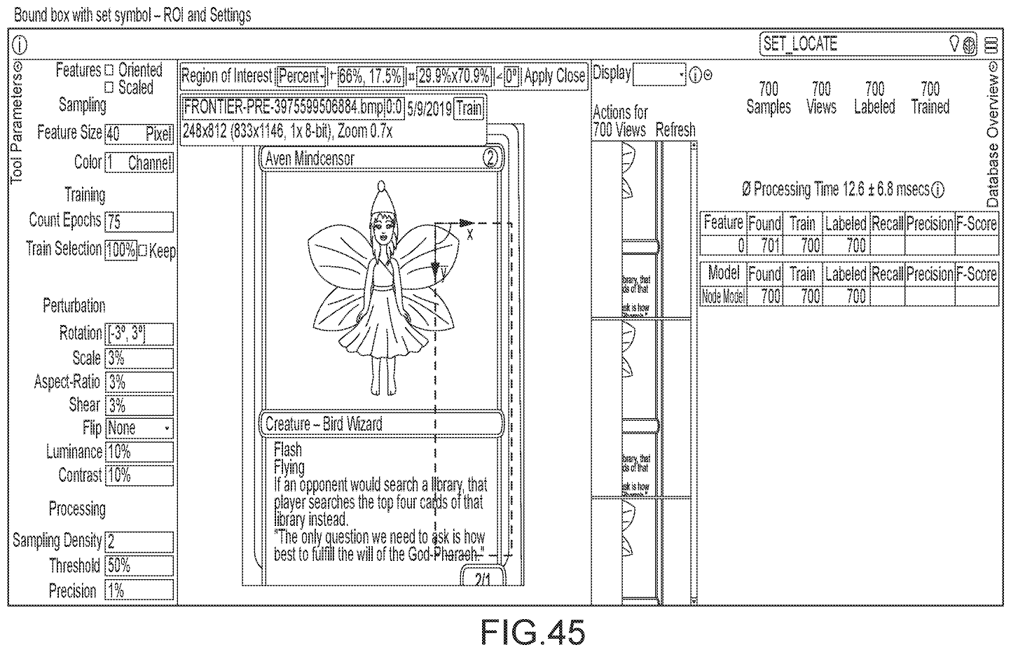

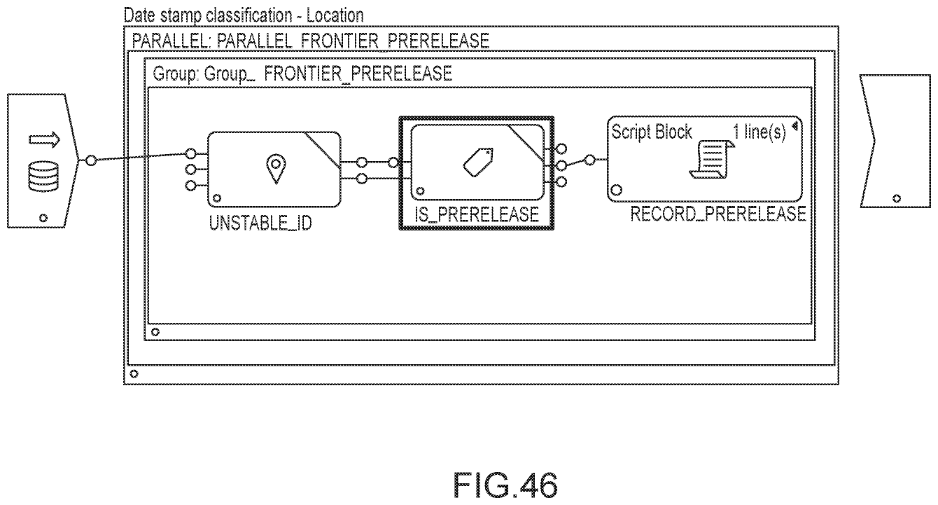

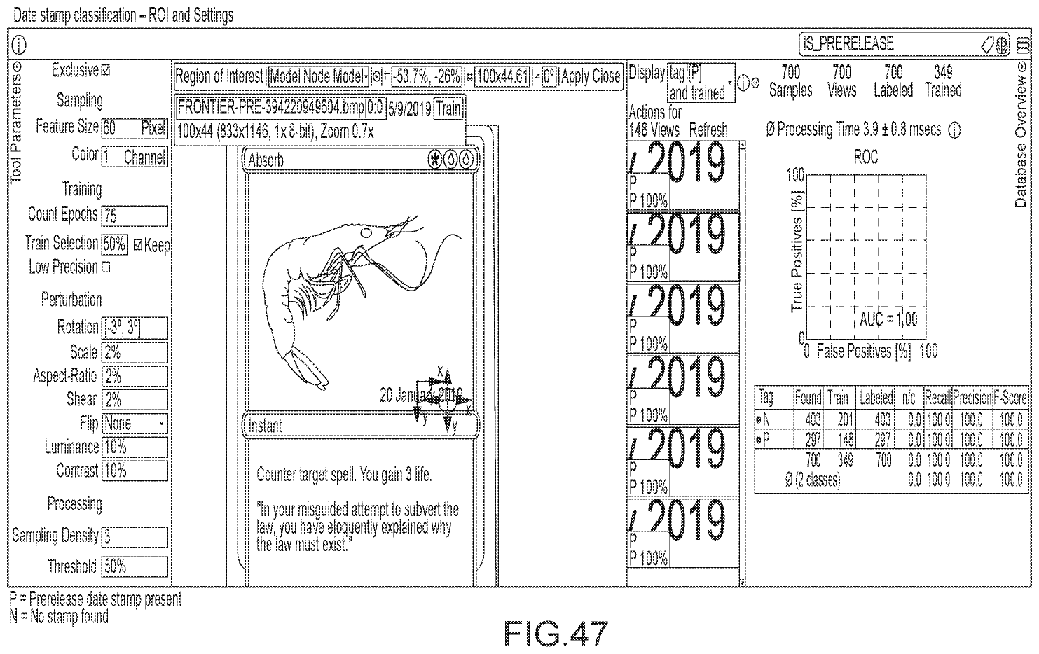

As shown in FIG. 28, the frontier primary classification subtask can include orienting scanned images based on a static feature and then using machine learning OCR to determine a card's edition, collector's number, foil variant, and rarity as depicted in FIGS. 29-37. As shown in FIG. 38, the unstable variant subtask can include first classifying images based on the a card's distinct artwork. If cards share artwork, the card is further classified based on the rules text box as depicted in FIGS. 39-42. Referring to FIG. 43, the frontier prerelease subtask can include first locating a bound box with a set symbol as shown in FIGS. 44 and 45 and then further classifying the card based on the presence of a date stamp as shown in FIGS. 46 and 47.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. It will be appreciated that the same thing can be said in more than one way.

Consequently, alternative language and synonyms may be used for any one or more of the terms discussed herein, and any special significance is not to be placed upon whether or not a term is elaborated or discussed herein. Synonyms for some terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

What is claimed is:

1. A system for automatically classifying collectable cards, the system comprising:
an image capture device; and
a controller, comprising:
one or more processors; and
one or more memory devices having stored thereon instructions that when executed by the one or more processors cause the one or more processors to:
receive image data from the image capture device corresponding to a collectable card;
determine a card style for the collectable card based on the image data;
process the image data according to the card style; and
assign a unique stock keeping unit (SKU) number to the collectable card.

2. The system of claim 1, wherein the card style is determined based at least in part on a color of an outer border of the collectable card.

3. The system of claim 1, wherein the card style is determined at least in part by whether the collectable card has a fixed or variable width title.

4. The system of claim 1, wherein the unique SKU number is read from an optical character recognition (OCR) readable tag on the collectable card.

5. The system of claim 1, wherein processing the image data includes converting the image data to gray scale.

6. The system of claim 5, wherein processing the image data includes excluding a selected color from the image data before converting the image to gray scale.

7. A method for automatically classifying collectable cards, the method comprising:
receiving, with a controller, image data corresponding to a collectable card;
determining, by the controller, a card style for the collectable card based on the image data;
processing, with the controller, the image data according to the card style; and
assigning, with the controller, a unique stock keeping unit (SKU) number to the collectable card.

8. The method of claim 7, wherein the card style is determined based at least in part on a color of an outer border of the collectable card.

9. The method of claim 7, wherein the card style is determined at least in part by whether the collectable card has a fixed or variable width title.

10. The method of claim 7, wherein the unique SKU number is read from an optical character recognition (OCR) readable tag on the collectable card.

11. The method of claim 7, wherein processing the image data includes converting the image data to gray scale.

12. The method of claim 11, wherein processing the image data includes excluding a selected color from the image data before converting the image to gray scale.

13. A processor readable memory device, comprising instructions stored thereon that when executed by one or more processors, cause the one or more processors to:
receive image data corresponding to a collectable card;
determine a card style for the collectable card based on the image data;
process the image data according to the card style; and
assign a unique stock keeping unit (SKU) number to the collectable card.

14. The memory device of claim 13, wherein the card style is determined based at least in part on a color of an outer border of the collectable card.

15. The memory device of claim 13, wherein the card style is determined at least in part by whether the collectable card has a fixed or variable width title.

16. The memory device of claim 13, wherein the unique SKU number is read from an optical character recognition (OCR) readable tag on the collectable card.

17. The memory device of claim 13, wherein processing the image data includes converting the image data to gray scale.

18. The memory device of claim 17, wherein processing the image data includes excluding a selected color from the image data before converting the image to gray scale.
